(19) United States
(12) Patent Application Publication
(10) Pub. No.: US 2026/0172061 A1
(43) Pub. Date: Jun. 18, 2026

(54) ENHANCED FEEDBACK SIGNAL ROUTING DESIGNS AND METHODS FOR ENHANCED TRANSCEIVER PERFORMANCE

(71) Applicant: QUALCOMM Incorporated, San Diego, CA (US)

(72) Inventors: Alireza Assadi, Irvine, CA (US); Ara Bicakci, Sunol, CA (US); Ngar Loong Alan Chan, San Jose, CA (US); Pavan Kumar Ramakrishna, San Jose, CA (US); Rabih Makarem, Irvine, CA (US)

(21) Appl. No.: 18/984,172

(22) Filed: Dec. 17, 2024

(51) Int. Cl. H04B 1/00; H04B 1/04; H04B 1/62

(52) U.S. Cl. CPC H04B 1/0078; H04B 1/04; H04B 1/62; H04B 2001/0425

(57) ABSTRACT

This disclosure provides systems, methods, and devices for wireless communications that support enhanced feedback routing operations, such as enhanced digital pre-distortion operations. In a first aspect, a transceiver includes a first transmit chain including a power amplifier and a first receive chain including a first mixer and a first baseband filter. The transceiver also includes a second receive chain having a second baseband filter, and includes feedback circuitry coupled to the power amplifier of the first transmit chain and to the first mixer of the first receive chain and configured to output a feedback signal to the first mixer. The transceiver further includes feedback routing circuitry coupled to the first baseband filter and to the second baseband filter and configured to provide the feedback signal received from the first mixer to the first baseband filter or to the second baseband filter. Other aspects and features are also claimed and described.

### TECHNICAL FIELD

Aspects of the present disclosure relate generally to wireless communication systems, and more particularly, to radio frequency (RF) processing circuitry for wireless communication systems. Some features may enable and provide improved communications, including enhanced feedback routing designs for transceivers, such as transceivers with dedicated or shared baseband filters.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

Modern wireless communication networks are sophisticated networks that involve operation on multiple frequencies and multiple frequency ranges. RF signals in different frequencies and ranges may use different components or different configurations of components to support a device operating on these wireless communication networks and maintain high signal integrity and high bandwidth across a range of possible network conditions. The number of supported configurations presents challenges in designing RF systems for the UEs and BSs operating on wireless communication networks.

One such example of a design challenge is efficiently supporting multi-path configurations and operating modes while providing feedback or loopback paths for purposes such as supporting digital pre-distortion (DPD) or similar features relying on feedback measurements. DPD techniques precorrect or preadjust for power amplifier distortion and non-linearity generated during the amplification of signals for wireless transmission. A DPD process may sample an output of a power amplifier, and loop back the sampled output or feedback to a digital baseband processor for correction of power amplifier caused non-linearity. However, the feedback or loopback of the sampled amplified signal for functions such as DPD correction presents challenges in RF systems with multiple transmit and receive chains, such as from unwanted coupling. In such multiple chain transceivers, the feedback may be looped back intra-chain or inter-chain. While, intra-chain routing generally has improved performance as compared to inter-chain routing, inter-chain routing is more compatible with advanced transceiver designs, and can work with shared baseband filter transceiver architectures, which reduce component duplication, area, and power consumption. Thus, each feedback routing method, inter or intra, has their own disadvantages.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a transceiver includes: a first transmit chain including a power amplifier; a first receive chain including a first mixer and a first baseband filter, wherein the first transmit chain and the first receive chain are associated with each other; a second receive chain including a second baseband filter and associated with a second transmit chain; feedback circuitry coupled to the power amplifier of the first transmit chain and to the first mixer of the first receive chain and configured to output a feedback signal to the first mixer; and feedback routing circuitry coupled to the first baseband filter and the first mixer of the first receive chain and to the second baseband filter of the second receive chain, and configured to provide the feedback signal received from the first mixer to the first baseband filter of the first receive chain or to the second baseband filter of the second receive chain.

In an additional aspect of the disclosure, a transceiver includes: a first transmit chain including a power amplifier; a first receive chain including a first mixer and a first baseband filter, wherein the first transmit chain and the first receive chain are associated with each other; a second receive chain including a second baseband filter and associated with a second transmit chain; digital pre-distortion (DPD) circuitry coupled to the power amplifier of the first transmit chain and to the first mixer of the first receive chain and configured to output DPD feedback to the first mixer; and DPD feedback routing circuitry coupled to the first baseband filter and the first mixer of the first receive chain and to the second baseband filter of the second receive chain, and configured to provide the DPD feedback received from the first mixer to the first baseband filter of the first receive chain or to the second baseband filter of the second receive chain.

In an additional aspect of the disclosure, a method for wireless communication includes: generate, by a feedback circuit, a feedback signal based on a transmission signal of a transmit chain; provide, by the feedback circuit, the feedback signal to a mixer of a receive chain corresponding to the transmit chain; mix, by the mixer, the feedback signal to generate a mixed feedback signal; and provide, by the mixer, the mixed feedback signal to a baseband filter of a different receive chain via routing circuitry.

In an additional aspect of the disclosure, a method for wireless communication includes: receiving, at a digital pre-distortion (DPD) module of a transmit chain, a transmission signal; generating, by the DPD module, a DPD feedback signal based on the transmission signal; providing, by the DPD module, the DPD feedback signal to a mixer of a receive chain corresponding to the transmit chain; mixing, by the mixer, the DPD feedback signal to generate a mixed DPD feedback signal; and providing, by the mixer, the mixed DPD feedback signal to a baseband filter of a different receive chain via DPD routing circuitry.

In another aspect of the disclosure, a transceiver includes: a first transmit chain including a first power amplifier; a first receive chain including a first mixer and a first baseband filter; a first shared baseband filter coupled to the first transmit chain and the first receive chain; a second receive chain including a second mixer and second baseband filter; a second shared baseband filter coupled to a second transmit chain and the second receive chain; feedback circuitry including an input coupled to an output of the first power amplifier of the first transmit chain and an output coupled to an input of the first mixer of the first receive chain; and routing circuitry coupled to the first shared baseband filter, the second shared baseband filter, the first mixer of the first receive chain, and the second mixer of the second receive chain, and including multiple routing paths, the multiple routing paths including intra-chain receive paths and inter-chain feedback paths.

In another aspect of the disclosure, a transceiver includes: a first transmit chain including a first power amplifier; a first receive chain including a first mixer and a first baseband filter; a first shared baseband filter coupled to the first transmit chain and the first receive chain; a second receive chain including a second mixer and second baseband filter; a second shared baseband filter coupled to a second transmit chain and the second receive chain; digital pre-distortion (DPD) circuitry including an input coupled to an output of the first power amplifier of the first transmit chain and an output coupled to an input of the first mixer of the first receive chain; and routing circuitry coupled to the first shared baseband filter, the second shared baseband filter, the first mixer of the first receive chain, and the second mixer of the second receive chain, and including multiple routing paths, the multiple routing paths including intra-chain receive paths and inter-chain DPD feedback paths.

As used herein, a “radio frequency” signal is a signal having a frequency above baseband, which includes, in an example embodiment of a heterodyne receiver, intermediate frequency signals.

As used herein, an “intermediate frequency” signal is an RF signal that has been downconverted from another RF signal to a frequency that is above baseband, such as in an example embodiment of a heterodyne mmWave transceiver that receives a mmWave RF signal and downconverts the mmWave RF signal to a mmWave IF signal that is further processed, such as through further downconversion, to a lower frequency RF signal or a baseband signal.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 is a block diagram illustrating a frequency (RF) receiver according to one or more aspects.

FIG. 4 is a block diagram illustrating a wireless transceiver that supports enhanced digital pre-distortion (DPD) routing operations according to one or more aspects.

FIG. 5 is a diagram illustrating an example of a wireless transceiver with inter-chain DPD routing according to one or more aspects.

FIG. 6 is a diagram illustrating an example of a wireless transceiver with intra-chain DPD routing according to one or more aspects.

FIG. 7 is a diagram illustrating an example of a wireless transceiver with hybrid DPD routing that supports enhanced DPD routing operations according to one or more aspects.

FIG. 8 is a diagram illustrating another example of a wireless transceiver with hybrid DPD routing that supports enhanced DPD routing operations according to one or more aspects.

FIG. 9 is a diagram illustrating another example of a wireless transceiver with hybrid DPD routing that supports enhanced DPD routing operations according to one or more aspects.

FIGS. 10A-10C are each a diagram illustrating an example of DPD routing circuitry that supports enhanced DPD routing operations according to one or more aspects.

FIG. 11 is a block diagram illustrating an example of DPD front end circuitry that supports enhanced DPD routing operations according to one or more aspects.

FIG. 12 is a flow diagram illustrating an example process that supports enhanced DPD routing operations according to one or more aspects.

FIG. 13 is a block diagram of an example UE that supports enhanced DPD routing operations in a wireless radio according to one or more aspects of the disclosure.

FIG. 14 is a block diagram of an example base station that supports enhanced DPD routing operations in a wireless radio according to one or more aspects of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long-term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2 ). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to WLAN, LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

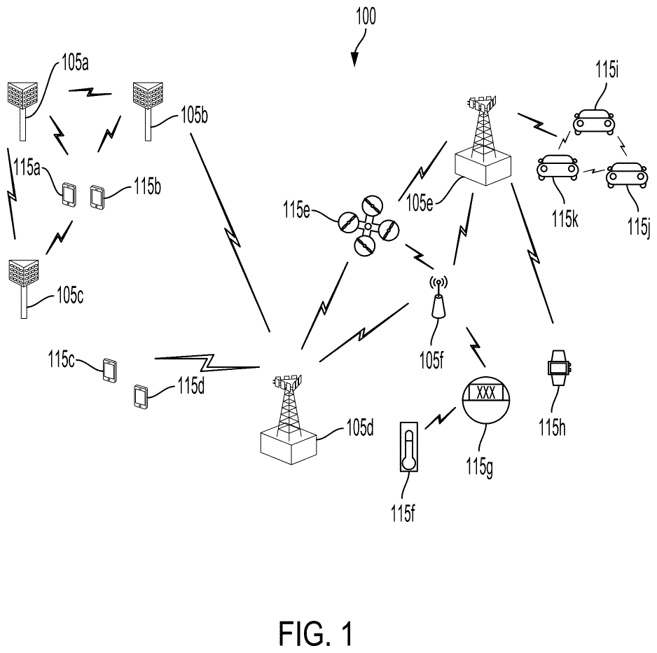

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100. A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

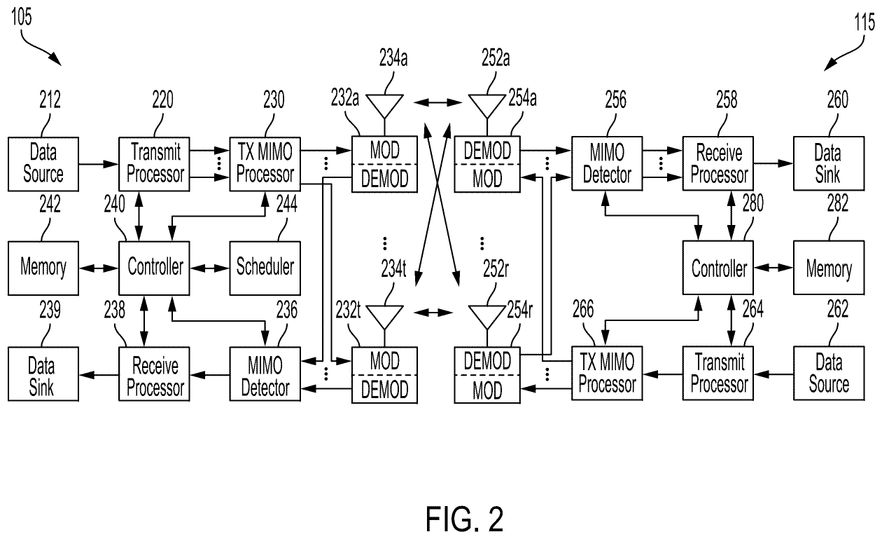

FIG. 2 is a block diagram illustrating examples of base station 105 (e.g., or access point) and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

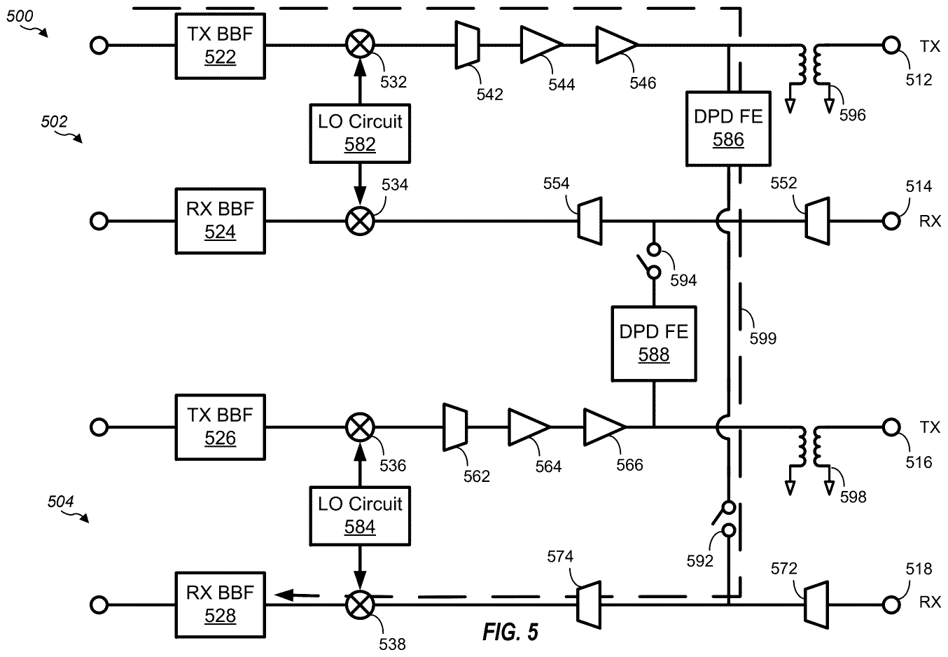

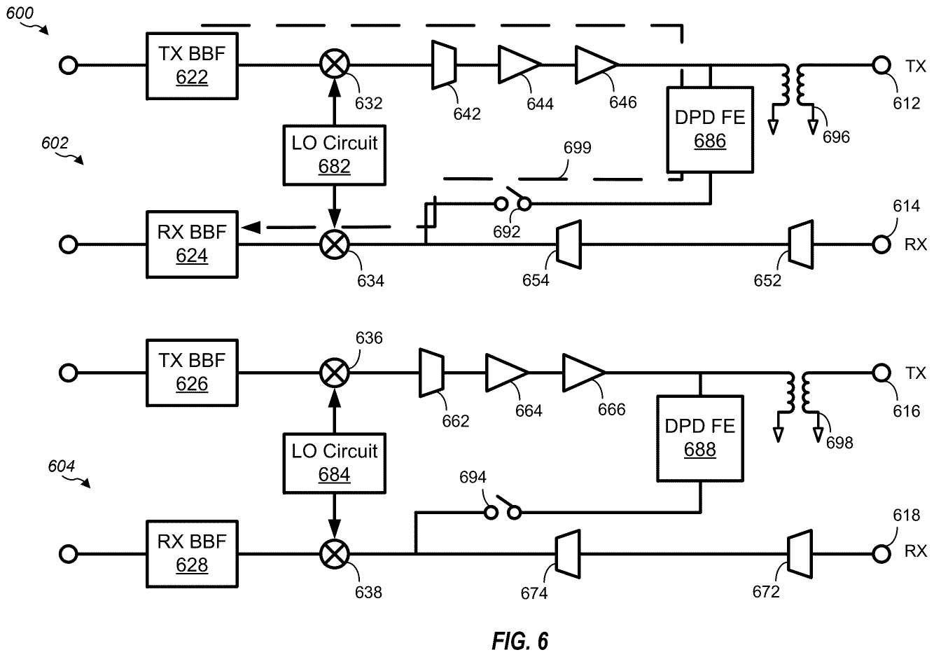

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIG. 5 or FIG. 6, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

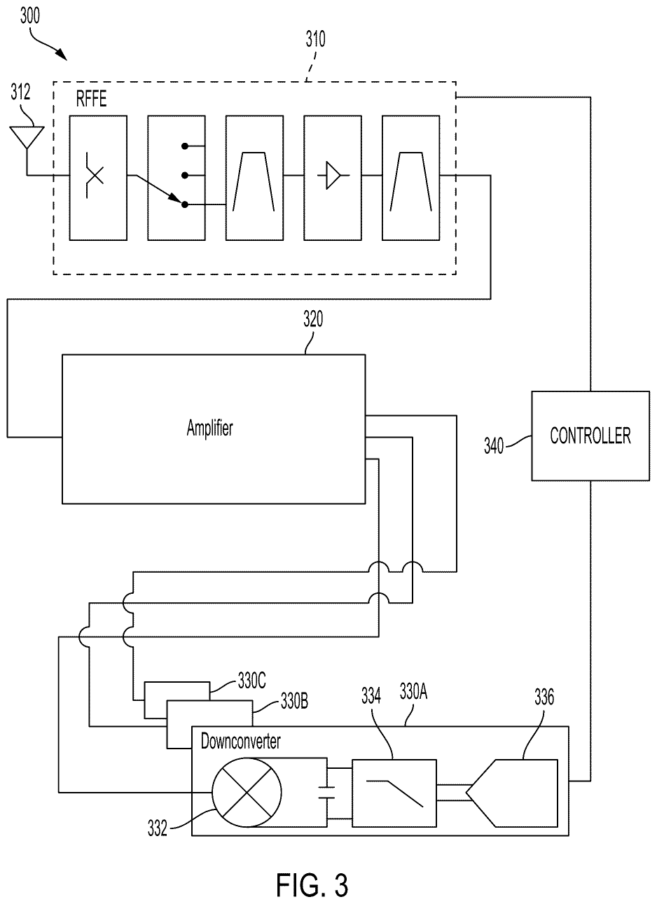

FIG. 3 is a block diagram illustrating a wireless receiver circuit, receive circuit 300, according to one or more aspects. In some embodiments, the receiver circuit 300 may be part of a Wi-Fi transceiver. In some embodiments, the receiver circuit 300 may be part of a converged sub-6 GHz and mmWave radio frequency (RF) transceiver, a sub-6 GHz radio frequency (RF) transceiver, or a mmWave radio frequency (RF) transceiver. In some embodiments, portions or all of the RF transceiver of FIG. 3 may be located in a single integrated circuit (IC) sharing a common substrate. The receiver circuit 300 may include an antenna 312 to receive radio frequency (RF) signals, such as a phase antenna array. The antenna 312 is coupled to an optional RF front-end (RFFE) 310, which may include duplexers, SAW filters, switches, LNAs, and/or other transmit or receive circuits for conditioning signals received from the antenna 312. In some embodiments, the RFFE 310 may include separate circuits for conditioning or otherwise processing sub-6 GHz signals, mmWave signals, satellite signals, and/or other signals. For example, the RFFE 310 may include a first plurality of circuits for conditioning a sub-6 GHz signal for further processing by other circuitry and a second plurality of circuits for conditioning a mmWave RF signal for further processing by other circuitry. The output of the RFFE 310 in this example may be an input RF signal to other circuitry comprising the conditioned sub-6 GHz signal. The RFFE 310 is coupled to an amplifier 320, such as a low noise amplifier (LNA). The amplifier 320 is coupled to one or more downconverters 330A, 330B, and 330C. Each of the downconverters 330A, 330B, and 330C may include mixers 332, baseband filters (BBFs) 334, and/or analog-to-digital converters (ADCs) 336. The downconverters 330A, 330B, 330C may include one or more harmonic rejection mixers (HRMs). In some embodiments, the amplifier 320 is shared on an IC with one or more of the RFFE 310 and/or the downconverters 330A, 330B, and 330C.

Interference between wireless signals received at antenna 312 and processed through RFFE 310, amplifier 320, and downconverters 330A-C complicates operation of the receiver circuit 300, particularly when processing a large range of potential frequencies.

Aspects herein may apply to carrier aggregation (CA) or similar techniques which involves the combination of one or more carrier RF signals to carry a single data stream. Carrier aggregation (CA) improves the flexibility of the wireless devices and improves network utilization by allowing devices to be assigned different numbers of carriers for different periods of time based, at least in part, on historical, instantaneous, and/or predicted bandwidth use by the wireless device. Thus, when a mobile device needs additional bandwidth, additional carriers may be assigned to that wireless device, and then de-assigned and re-assigned to other mobile devices when bandwidth demands change. As carriers are assigned and de-assigned from a mobile device, the interaction of wireless signals may change. For example, different carriers in CA may be in different bands, and certain bands may have harmonics that overlap and/or otherwise interfere with certain other bands.

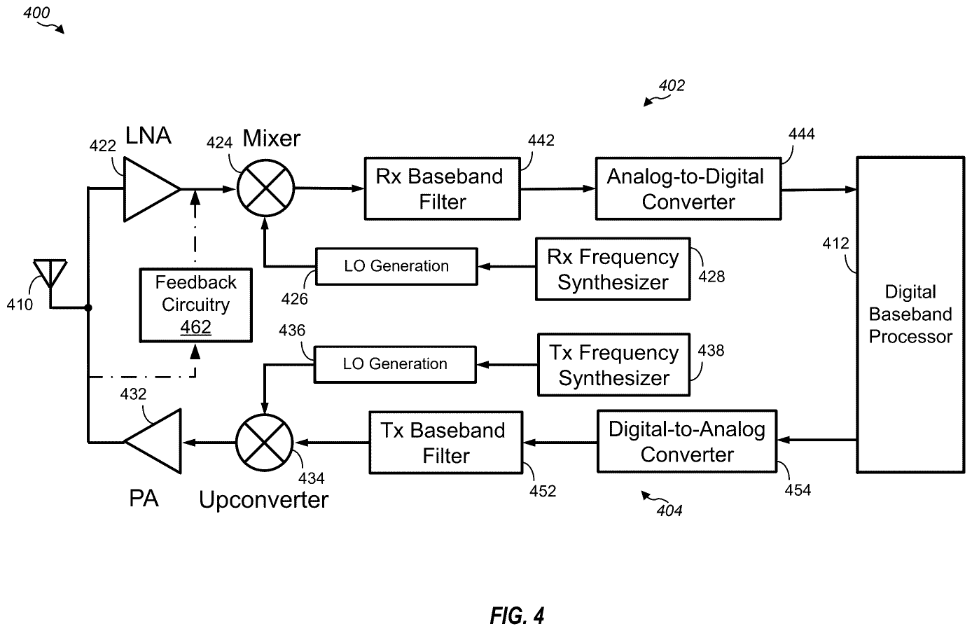

A controller 340 may detect conditions in the RF signal received from the antenna 312 or receive information regarding the carrier configuration from higher levels, such as a MAC layer or network layer. The controller 340 may configure components of the receiver circuit 300 to activate, deactivate, or control portions of the receiver circuit 300 to process an input RF signal. In some embodiments, the controller 340 configures components to reduce power consumption, calibrate components, and/or reduce interference between bands within the receiver circuit 300. In some embodiments, the controller 340 may configure DPD routing circuitry to provide DPD feedback intra-chain or inter-chain in one or more processing paths within the RFFE 310, as described further with reference to FIGS. 4-11.

When engaging in operations that utilize transmit chain feedback, such as internal or on-chip feedback operations (one example of which is DPD feedback operations), feedback can be routed to the baseband processor in at least one of two ways, intra-chain or inter-chain. Intra-chain routing involves providing the feedback from a particular transmit chain to a corresponding receive chain, such as receive chain of a shared channel or an adjacent receive chain which shares components with the transmit chain (e.g., a receive chain that shares a baseband filter with the transmit chain). Inter-chain routing involves providing the feedback from a particular transmit chain to a non-adjacent receive chain that is outside of the channel of the transmit chain and optionally to a receive chain that does not share components with the transmit chain (e.g., does not share a baseband filter). Specifically, in inter-chain routing a feedback output or signal from a transmit chain is and provided to the other receive chain. In the case of DPD operations, in inter-chain routing an output from a power amplifier of a transmit chain is processed by a front end unit (e.g., DPD front end circuitry) and provided to a mixer (e.g., downconverter) of the other receive chain. The inter-chain routing may enable reduction of components by enabling sharing of components between transmit chains and receive chains (e.g., baseband filters). However, the inter-chain routing is usually much longer than intra-chain routing and the longer path occurs in the RF portion of the transceiver (e.g., the DPD feedback signal is routed to other chain while in a RF frequency spectrum), which is more susceptible to interference and unwanted coupling and requires more power.

Due to the above disadvantages inter-chain routing, transmit chain feedback, such as power amplifier output feedback, was often provided intra-chain, as such routing configurations offer improved performance, especially in the RF portion. However, such intra-chain routing is not possible in transceivers where a baseband filter or processor is shared between a transmit chain and a receive chain. For example, as advanced transceivers are being designed with more transmit and receive chains for improved operations in multiple frequency ranges/communication protocols and for improved bandwidth and/or concurrent operations, transceiver designs have begun to use shared baseband filters and/or processors for corresponding transmit and receive chains to reduce area and power consumption. Thus, both types of conventional intra-chain or inter-chain routing designs and methods present transceiver designers with disadvantages.

The aspects described herein are directed to improving transceiver performance for feedback operations, including improving linearity and reducing distortion, interference and unwanted coupling. The aspects herein also enable the transceiver to utilize advanced shared transmit and receive component designs to further reduced area and power consumption during all transceiver operations. For example, the transceiver designs herein leverage both intra-chain and inter-chain routing to improve linearity without sacrificing area or power consumption. The transceiver designs include intra-chain routing in a RF portion of the transmit and receive chains and configurable routing circuitry in a baseband portion of the receive chains that can route signals either inter-chain or intra-chain to form a flexible and configurable “hybrid” routing scheme.

In the aspects described herein, hybrid routing configurations are provided which can route the feedback signal inter-chain or intra-chain to leverage the benefits of both types while simultaneously reducing the drawbacks of both. For example, the hybrid routing configurations may include routing circuitry configured to provide the feedback signal from a transmit chain to a corresponding receive chain (e.g., adjacent receive chain) or another receive chain (e.g., second receive chain which does not share baseband circuitry). The hybrid routing configurations enables a transceiver to be designed with dedicated or shared baseband filters and still leverage the benefits of intra-chain feedback routing in a RF portion. Accordingly, transceiver performance is improved through reduced interference and unwanted coupling, and reduced power consumption from the shorter intra-chain RF path, and the transceiver is compatible with additional advanced shared component designs.

Additionally, in some aspects described herein, a transceiver may include shared baseband filters for transmit and receive chains to reduce component duplication. Shared baseband filter designs have reduced components, which reduces transceiver size, cost, complexity, and power consumption. In addition, the hybrid routing configurations described herein can enable shared baseband filter designs to leverage intra-chain routing in an RF portion of the routing to improve transceiver performance, such as linearity and power consumption. Accordingly, transceiver performance can be improved for advanced transceiver designs.

FIG. 4 is a circuit diagram illustrating a wireless transceiver circuit 400 according to one or more aspects. In some embodiments, portions of the RF transceiver of FIG. 4 may be located in a single integrated circuit (IC) sharing a common substrate, and each portion may be coupled to each other and to a PCB.

The wireless transceiver circuit 400 includes a plurality of receive chains and plurality of transmit chains. In the example of FIG. 4, a single receive chain, first receive chain 402, and a single transmit chain, first transmit chain 404, are illustrated for simplicity. The wireless transceiver circuit 400 may include many more receive chains and/or transmit chains. The additional transmit or receive chains may be grouped together, such as groups of receive chains or groups of transmit chains. For example, in a particular implementation, the wireless transceiver circuit 400 may include 8 groups of 8 receive chains for a total of 64 receive chains. Each group of receive chains may include or correspond to a separate chip or a portion of a chip which is implemented on a PCB in some implementations.

The receive chains of the wireless transceiver circuit 400 may include or correspond to receive chains, feedback receive chains, or a combination thereof. Although the example of FIG. 4 is directed to an example of receive (RX) chains, in other implementations the receive chains may be feedback receive (FBRX) chains and have similar or identical components and/or operations.

Each receive chain may include a corresponding amplifier, mixer, and LO generation circuitry. For example, the first receive chain 402 includes an amplifier 422, a mixer 424 (e.g., downconverter), and LO generation circuitry 426. Each receive chain may be configured to receive a respective RF input signal from a corresponding antenna, such as antenna 410.

Each transmit chain may include a corresponding amplifier, mixer, and LO generation circuitry. For example, the first transmit chain 404 includes an amplifier 432, a mixer 424 (e.g., upconverter), and LO generation circuitry 436. Each transmit chain may be configured to receive multiple types of input signals. For example, each transmit chain may be configured to receive a corresponding respective signal for transmission by a corresponding antenna, such as antenna 410 and/or calibration signals.

The amplifier, amplifier 422, of each receive chain may include or correspond to a low-noise amplifier (LNA) or other type of amplifier in a receive chain. In some implementations, the amplifier may include or correspond to a linear amplifier. The amplifier is configured to amplify received input signals, such as the received RF signals from a corresponding antenna. The amplifier 422 may include or correspond to one-stage LNA or a two-stage LNA in some implementations.

The amplifier 432 of each transmit chain may include or correspond to a power amplifier or other type of amplifier in a transmit chain. In some implementations, the amplifier 432 may include or correspond to a linear amplifier. The amplifier 432 is configured to amplify received input signals, such as the RF signals to be transmitted by a corresponding antenna. The amplified signals from the amplifier 432 may be provided to the antenna 410 for transmission or to feedback circuitry 462 for processing and generation of a feedback signal. In the DPD-based example of FIG. 4, the amplified signals from the amplifier 432 may be provided to DPD circuitry (e.g., DPD feedback circuitry) for DPD processing. The DPD circuitry may be part of the feedback circuitry 462 or may correspond to the feedback circuitry 462. In other aspects, other types of feedback may be generated by the feedback circuitry 462 or by second feedback circuitry based on an amplified signal from the amplifier 432 or based on upconverted RF signals from the mixer 424.

The mixer, mixers 424 and 434, of each chain may include or correspond to a frequency mixer or multiplier configured to generate a new signal, including or having one or more new frequencies, based on two signals applied to it, such as the difference of the frequencies of the two signals applied to it. Each mixer is configured to generate an output based on a corresponding pair of an input signal and a local oscillator signal. In the example of FIG. 4, the input signal may include or correspond to received signals from a corresponding antenna, and the local oscillator signal may include or correspond to an adjusted (e.g., divided or reduced) local oscillator signal that is received from an external local oscillator (e.g., external phase locked loop (PLL)) and adjusted based on a corresponding on-chip divider. The mixer may include or correspond to a passive mixer or an undriven mixer in some implementations. Additionally, or alternatively, the mixer may include or correspond to an unbalanced mixer, a single-balanced mixer, or a double-balanced mixer. The mixer may include one or more circuit components such as transistors or diodes to generate the output.

The mixer 424 of the receive chain 402 may include or correspond to a downconverter and may convert RF signals to BB signals, that is signals from a RF frequency range to signals of a BB frequency range. The mixer 434 of the transmit chain 404 may include or correspond to an upconverter and may convert BB signals to RF signals, that is signals from a BB frequency range to signals of a RF frequency range.

The LO generation circuitry, LO generation circuitry 426 and 436, of each chain may include or correspond to circuitry configured to generate a LO signal based on a synchronization signal or clock signal from signal generation circuitry, such as the frequency synthesizers 428 or 438.

The frequency synthesizers 428 and 438 of each chain may include or correspond to synchronization signal or clock signal generation circuitry. For example, the frequency synthesizers 428 and 438 may be configured to generate a signal with a particular frequency for LO processing and LO signal generation for mixing or upconverting. The LO signal may enable further baseband processing (e.g., baseband filtering) for receiving RF signals and generation of RF signals for transmission. With this architecture, each receive chain and/or transmit chain may have a corresponding LO generation circuit and be capable of performance in many modes. Attentively, in other implementations, multiple chains or pairs of receive and transmit chains may share a LO generation circuit and/or frequency synthesizer.

The receive baseband filter 442 of each receive chain may include or correspond to filter circuitry configured to filter out signals outside of baseband frequencies generated by the mixer 424.

The ADC 444 of each receive chain may include or correspond to ADC circuitry configured to convert a received analog signal back to its digital signal, sequence of bits, it was created from. For example, a signal with varying frequency and/or amplitude may be converted to a sequence of bits with bit values corresponding to the frequency and/or amplitude.

The transmit baseband filter 452 of each of each transmit chain may include or correspond to transmit baseband filter circuitry configured to filter the converted analog signal for mixing and transmission by the antenna 410.

The DAC 454 of each transmit chain may include or correspond to DAC circuitry configured to convert a digital signal, e.g., a sequence of bits, to an analog signal, such as a signal with varying frequency and/or amplitude which indicates or corresponds to bit values of the sequence.

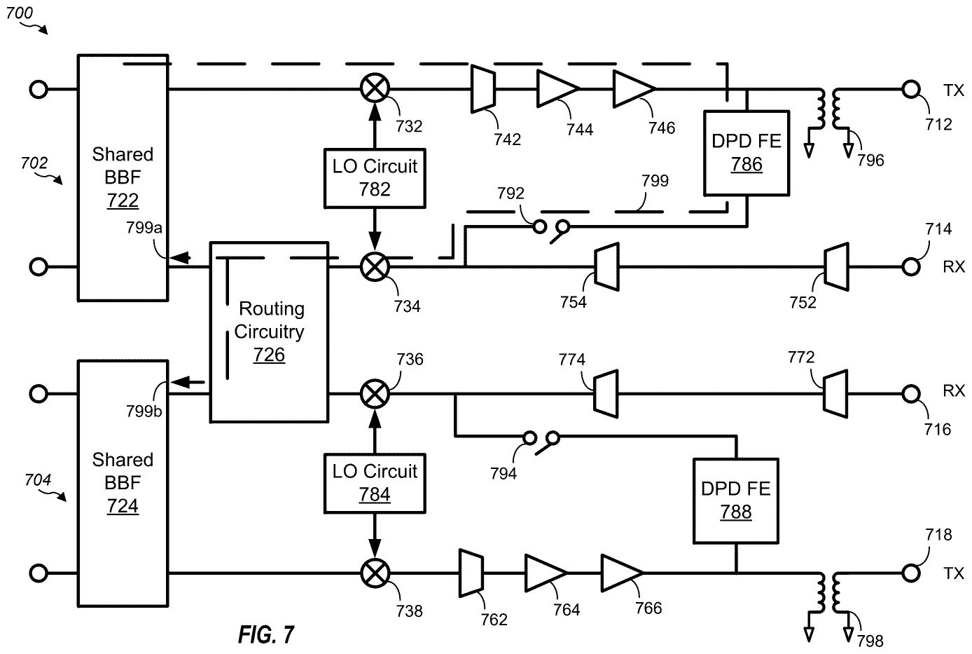

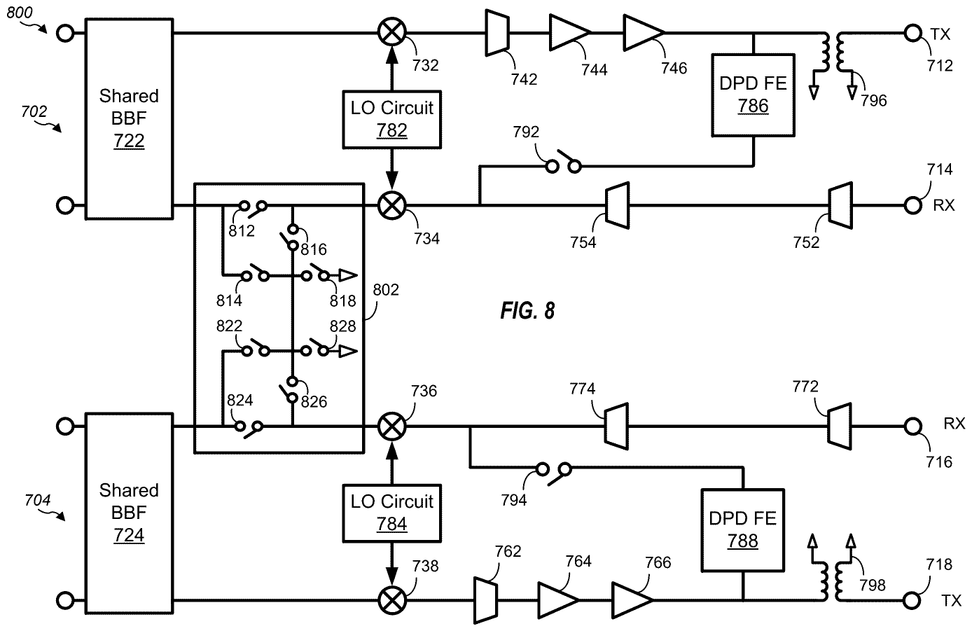

Although the wireless transceiver circuit 400 includes separate receive and transmit baseband filters, that is receive baseband filter 442 and transmit baseband filter 452, in the example of FIG. 4, in other implementations the wireless transceiver circuit 400 may include a single, shared baseband filter for both the receive chain 402 and the transmit chain 402, such as described further with reference to FIGS. 7 and 8.

The wireless transceiver circuit 400 includes one or more antennas, such as antenna 410, and a digital baseband processor 412. The antenna 410 is configured to transmit and receive RF energy corresponding to RF signals. The digital baseband processor 412 includes or corresponds digital baseband processing circuitry and is configured to process data for transmission and to process data from received RF signals. For example, the digital baseband processor 412 may include or correspond to the BBF 334 as in FIG. 3.

The digital baseband processor 412 is coupled to and configured to receive outputs from the receive chains and process the output of the receive chains. For example, the digital baseband processor 412 is configured to receive a corresponding digital output (e.g., a sequence of zeros and ones corresponding to the filtered analog signal) from each receive chain of the plurality of receive chains 402-408 and to perform baseband processing on the output.

Although the digital baseband processor 412 is coupled to the output of the respective ADC of each receive chain and configured to receive a respective output of each receive chain in FIG. 4, the output of receive chain may bypass the digital baseband processor 412 in some implementations, such as by the use of switches, traces, or other bypass circuitry. For example, during calibration, the output of each receive chain may physically bypass the digital baseband processor 412 and be directed to RF calibration processing or may pass through the digital baseband processor 412 without the digital baseband processor 412 processing the signal.

Additionally, the digital baseband processor 412 is configured to generate signals for wireless transmission. For example, the digital baseband processor 412 is configured to receive data and generate one or more sequences of bits for conversion to an analog signal based on and/or indicating the data. The digital baseband processor 412 is coupled to and configured to provide signals to the transmit chains.

The digital baseband processor 412 may also be configured to perform or coordinate DPD operations. For example, the digital baseband processor 412 may include processing circuitry to receive DPD feedback signals and generate DPD compensated signals or to generate control signals for generating DPD compensated signals. To illustrate, the digital baseband processor 412 may include a DPD compensator or predistorter configured to generate signals for wireless transmission based on the DPD feedback signals and that have been preadjusted or compensated for power amplifier non-linearity and distortion. Alternatively, the digital baseband processor 412 may include a controller configured to instruct a separate DPD compensator or predistorter to generate the DPD compensated signals.

The feedback circuitry 462 of or associated with the transmit chain 404 is configured to generate a feedback signal based on a transmit chain signal, such as the amplified signal received from the amplifier 432 or another signal in the RF region (e.g., downstream from the mixer). The feedback signal is provided from the feedback circuitry 462 back to the digital baseband processor 412 via the receive chain 406 for processing and performance of feedback based operations, error correction calibration, power control, etc. Examples of the feedback circuitry 462 are described further with reference to FIGS. 5-11. In the example of FIG. 4, the feedback circuitry 462 (or feedback circuit) is or includes DPD circuitry.

The DPD circuitry may include or correspond to a DPD front end (FE) unit or module, such as DPD FE circuitry (e.g., DPD feedback circuitry). The DPD circuitry is configured to generate a DPD feedback signal based on the amplified signal received from the amplifier 432. For example, the DPD circuitry may sample the amplified signal to generate the DPD feedback signal. The DPD feedback signal may be proportional to the amplified signal, such as proportional to the voltage thereof. For example, the DPD feedback signal may have a current that is proportional to the voltage thereof. Additional description of DPD circuitry and examples therefore are further shown and described with reference to FIGS. 5-9 and 11.

The DPD circuitry provides the DPD feedback signal to the digital baseband processor 412. In the example, of FIG. 4, the DPD circuitry outputs the DPD feedback signal to the mixer 424 for downconverting the DPD feedback signal to a BB frequency range and the DPD feedback signal (e.g., a downconverted DPD feedback signal) is provided to the digital baseband processor 412 via the receive chain 402, such as via the receive baseband filter 442 and the ADC 444.

The digital baseband processor 412, or DPD unit thereof, may process the received DPD feedback signal and may generate a signal for transmission based on the received DPD feedback signal. For example, the digital baseband processor 412, the DPD unit, or a predistorter thereof may predistort the signal for transmission so that when the predistorted signal is amplified by the amplifier 432 it has improved linearity (e.g., reduced non-linearity). Although the example of FIG. 4 is explained in terms of providing DPD feedback or power amplifier related feedback, in other operations, the wireless transceiver circuit 400 may provide other types of transmit chain feedback in addition or in the alternative of DPD feedback. Other examples of operations and/or circuitry that may relay on feedback paths and operations as described herein may include calibration operations, error correction, power control, and the like. The aspects herein may enable transmit chain feedback, including transmit chain feedback created in or routed in the RF region and/or created by or after amplification (e.g., by a power amplifier), to be routed more efficiently with reduced unwanted coupling and power loss. The reduction unwanted coupling and power loss, improves power efficiency as less gain is required for the feedback signals and systems.

FIGS. 5 and 6 illustrate specific examples of inter-chain and intra-chain feedback/loopback routing respectively, and FIGS. 7-9 illustrate hybrid feedback/loopback routing examples. Operation of the various routing examples are described further with reference to FIGS. 5-10C. The aspects described herein correspond to internal or on-chip feedback operations and routing (e.g., where the routing is done on the same chip as the power simplifier and/or feedback unit), and are different from other external feedback or DPD operations where the DPD feedback or the like is either generated off-chip or sent off-chip and then routed back to the chip (e.g., baseband processor) via a receive chain or other circuitry.

FIG. 5 is a circuit diagram illustrating a wireless transceiver circuit 500 according to one or more aspects. The wireless transceiver circuit 500 may include or correspond to a wireless transceiver circuit 500 for inter-chain routing. In some embodiments, portions of the RF transceiver (or receiver thereof) of FIG. 5 may be located in a single integrated circuit (IC) sharing a common substrate, and each portion may be coupled to each other and to a PCB.

The wireless transceiver circuit 500 includes a plurality of receive chains and a plurality of transmit chains. As illustrated in FIG. 5, the wireless transceiver circuit 500 includes or corresponds to a portion of a wireless transceiver circuit, such as two pairs of corresponding transmit and receive chains of a wireless transceiver. The pairs of corresponding transmit and receive chains may include or correspond to a particular channel of the wireless transceiver circuit 500, such as a first channel 502 and a second channel 504. The wireless transceiver circuit 500 may include many more pairs or sets of chains or channels. For example, in a particular implementation, the wireless transceiver circuit 500 may include 8 groups of 8 channels for a total of 64 receive chains and 64 transmit chains. Each group of channels may include or correspond to a separate chip or portion of chip.

In the example of FIG. 5, each channel includes a transmit chain and a receive chain, such as the first channel 502 includes a first transmit chain 512 and a first receive chain 514, and the second channel 504 includes a second transmit chain 516 and a second receive chain 518. Although the example FIG. 5 is directed to an example with pairs of chains and a channel including a transmit chain (TX) and a receive (RX) chain, in other implementations the wireless transceiver circuit 500 may also include one or more feedback receive (FBRX) chains which have similar or identical operation to the receive chains. In some such implementations, a channel may have three chains, such as TX chain, an RX chain and a FBRX chain.

Each transmit chain 512 and 514 includes transmit chain circuitry configured to process a signal for wireless transmission and includes or is coupled to a least one feedback circuit that is configured to generate a feedback signal based on a signal from the transmit chain. In the example of FIG. 5, each transmit chain 512 and 514 includes a corresponding mixer, amplifier, and DPD FE circuitry (or other generic feedback front-end circuitry for sampling or obtaining a portion of an output of the transmit chain for various purposes including but not limited to DPD). For example, the first transmit chain 512 includes a first mixer 532, a first amplifier 546, and first DPD FE circuitry 586, and the second transmit chain 516 includes a second mixer 536, a second amplifier 566, and second DPD FE circuitry 588. In other examples, each transmit chain 512 and 514 may include a different transmit chain sampling circuit or processing component (e.g., amplifier), in addition to or in the alternative of the DPD FE circuitry, that is configured to generate transmit chain feedback for intra-chain feedback routing. Each transmit chain may optionally include additional processing or amplification circuitry, such as a differential amplifier (DA), a pre-amplifier (e.g., preamp or pre-PA), a transformer, or a combination thereof. For example, the first transmit chain 512 may optionally include one or more of a first DA 542, a first pre-amplifier 544, or a first transformer 596, and the second transmit chain 516 may optionally include one or more of a second DA 562, a second pre-amplifier 564, or a second transformer 598.

The mixer, mixers 532 and 536 of each transmit chain 512 and 514 may include or correspond to a frequency mixer or multiplier configured to generate a new signal, including or having one or more new frequencies, based on two signals applied to it, such as the different frequencies of the two signals applied to it, often referred to as upconverter. Each mixer is configured to generate an output based on a corresponding pair of an input signal and a local oscillator signal (not shown). The mixer may include or correspond to an unbalanced mixer, a single-balanced mixer or a double-balanced mixer. The mixer may include one or more circuit components such as transistors or diodes to generate the output.

The amplifier, amplifiers 546 and 566, of each transmit chain 512 and 514 may include or correspond to a power amplifier or other type of amplifier in a transmit chain. In some implementations, the amplifier may include or correspond to a linear amplifier. The amplifiers 546 and 566 are configured to amplify received input signals, such as a received output RF signal for transmission by a corresponding antenna or a receive output RF signal for DPD processing and feedback to a baseband processor or a DPD correction module.

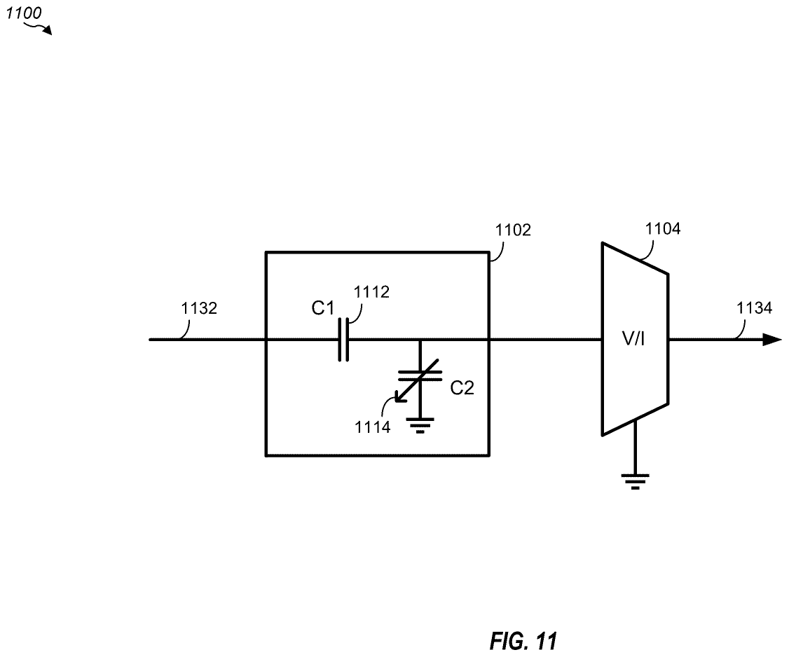

The first DPD FE circuitry 586 and the second DPD FE circuitry 588 may each include or correspond to feedback circuitry or a feedback circuit, such as the feedback circuitry 462 of FIG. 4. Each of the first DPD FE circuitry 586 and the second DPD FE circuitry 588 is included in or associated with its respective transmit chain and configured to generate a feedback signal (e.g., DPD feedback signal) based on a respective transmit chain signal, such as an amplified signal received from a respective amplifier or another transmit chain signal in the RF region (e.g., downstream from a respective mixer). One representative example of a DPD feedback circuit that can be used as the first DPD FE circuitry 586 or the second DPD FE circuitry 588 is provided in FIG. 11.

Each transmit chain 512 and 514 may be configured to receive multiple types of input signals. For example, each transmit chain 512 and 514 may be configured to receive a corresponding respective output signal (e.g., wireless transmission signal) from a corresponding baseband filter and for a corresponding antenna (not shown). Additionally, each transmit chain 512 and 514 may be configured to receive multiple versions of the output signal, such as an original or unmodified output signal and a DPD processed signal, such as predistorted signal. For example, each transmit chain 512 and 514 may generate a feedback signal based on an original output signal or an unmodified output signal and provide the feedback signal to the baseband processor (not shown) or a DPD correction module (e.g., predistorter) (not shown). A transmit chain may receive a DPD compensated or processed signal, such as predistorted signal, that corresponds to the original output signal or a second output signal. DPD compensated signal may reduce distortion and non-linearity when amplified and transmitted by the transmit chain due to DPD operations.

As illustrated in the example of FIG. 5, each transmit chain 512 and 514 includes an inter-chain feedback path. For example, the first transmit chain 512 of the first channel 502 provides its feedback to the second receive chain 518 of the second channel 504, and the second transmit chain 516 of the second channel 504 provides its feedback to the first receive chain 514 of the first channel 502. The feedback is provided inter-chain (e.g., across channels) in a RF frequency range and is downconverted to a BB frequency range on the receive chain of a different channel. The inter-chain paths may include switches or other circuitry, such as first switch 592 and second switch 594, to provide isolation when feedback is not in use. As described above, inter-chain routing may have certain advantages for some operations, and is compatible with both dedicated and shared component architectures for transceiver channels, such as shared baseband filter designs as described further with reference to FIGS. 7 and 8.

Each receive chain 514 and 518 includes receive chain circuitry configured to process a received wireless signal for decoding. In the example of FIG. 5, each receive chain 514 and 518 includes a corresponding mixer and amplifier. For example, the first receive chain 514 includes a first mixer 534 and a first amplifier 554, and the second receive chain 518 includes a second mixer 538 and a second amplifier 574. Each receive chain 514 and 518 may optionally include one or more additional components. For example, each receive chain 514 and 518 may include additional amplifiers or processing circuitry. As illustrated in the example of FIG. 5, the first receive chain 514 includes a third amplifier 552 and the second receive chain 518 includes a fourth amplifier 572. In some aspects, the amplifiers of each chain may include or correspond to a two-stage amplifier. For example, the first and third amplifiers 552 and 554 may include or correspond to a two-stage amplifier or two-stage LNA, including a first cascode or LNA phase and a second GM phase.

Each receive chain 514 and 518 may be configured to receive multiple types of input signals. For example, each receive chain 514 and 518 may be configured to receive a corresponding respective received signal from a corresponding antenna (not shown) and may be configured to receive a feedback signal as described above. The received communication signals and feedback signal may include or correspond to different types of signals or waves. For example, the received signals from antennas may include or correspond to received RF or analog signals while the feedback signal may include or correspond to a digital signal or square wave.

The amplifier, amplifiers 552, 554, 572, 574, of each receive chain 514 and 518 may include or correspond to a low noise amplifier or other type of amplifier in a receive chain, such as a transconductance or transimpedance amplifier. In some implementations, the amplifiers may include or correspond to a linear amplifier. The amplifier is configured to amplify received input signals, such as the received RF signals from a corresponding antenna or the reference signal 460. In some implementations, feedback signals may be configured to pass around the amplifier(s) (e.g., through bypass circuitry) or to go through the amplifier in a different mode than received wireless communication signals. For example, the amplifier may amplify or process the feedback signals to a lesser extent than received signals or not at all, such as in a zero gain mode.

The mixer, mixers 534 and 538, of each receive chain 514 and 518 may include or correspond to a frequency mixer or multiplier configured to generate a new signal, including or having one or more new frequencies, based on two signals applied to it, such as the difference of the frequencies of the two signals applied to it. The mixers 534 and 538 may be each be referred to as downconverter. Each mixer is configured to generate an output based on a corresponding pair of an input signal and a local oscillator signal. The mixer may include or correspond to an unbalanced mixer, a single-balanced mixer or a double-balanced mixer. The mixer may include one or more circuit components such as transistors or diodes to generate the output.

In the example of FIG. 5, each channel may have a corresponding LO generation circuit to provide the input or LO signals for the mixers. For example, the first channel 502 includes first LO circuitry 582 configured to generate LO signals for the mixers 532 and 534 of the first channel 502, and the second channel 504 includes second LO circuitry 584 configured to generate LO signals for the mixers 536 and 538 of the second channel 504. Alternatively, in some other implementations each chain may have its own LO generation circuit, as described with reference to FIG. 4, or multiple channels may share a single LO generation circuit, such as a single LO generation circuit for multiple or all transmit or receive chains or for the first and second channels 502 and 504. Although not shown for clarity, the wireless transceiver circuit 500 may include one or more additional components, such as additional RF front end components of filters, resistors, capacitors, inductors, switches traces, etc.

The wireless transceiver circuit 500 may also be coupled to an antenna, such as antenna 410 of FIG. 4, and configured to receive RF energy received by the antenna. For example, the receive chains 514 and 518 of the wireless transceiver circuit 500 may be configured to receive amplified RF energy from the antenna (e.g., an RX input as shown in FIG. 5).

During operation, the wireless transceiver circuit 500 may receive RF signals on one or more channels. For example, the wireless transceiver circuit 500 may receive a RF signal on the first receive chain 514, the second receive chain 518, or both. Wireless RF signals are received via one or more corresponding antennas and provided to a corresponding receive chain. RF signals on the receive chains 514 and 518 are processed by the components thereof and provided to the corresponding receive baseband filter of the receive chain, one of first receive baseband filter 524 or second receive baseband filter 528. The wireless signals are provided from the corresponding mixer on the receive chain to the corresponding dedicated receive baseband filter on the receive chain. To process the received RF signal at the mixer 534, the received RF signal may need to be amplified by the amplifiers 552 and 554 before being mixed and downconverted to baseband frequencies for processing by a baseband processor. To process the received RF signal at the mixer 534, an LO signal is also generated by the LO circuitry 582 and provided to the mixer 534 by the LO circuitry 582, as known in the art. The mixer 534 processes (e.g., mixes) the two received signals to generate a processed, mixed, or baseband signal for further/baseband filtering processing by the receive baseband filter 524 and the baseband processor.

During operation, the wireless transceiver circuit 500 may transmit wireless signals on one or more channels. For example, the wireless transceiver circuit 500 may transmit a wireless signal on the first transmit chain 512, the second transmit chain 516, or both. Wireless signals are generated by a baseband processor (not shown), provided to a corresponding transmit chain, and transmitted via one or more corresponding antennas (not shown). Wireless signals on the transmit chains 512 and 516 are processed by the components thereof and provided to the antenna for transmission, similar to the receive chains and as known in the art. For example, a signal for transmission is upconverted from a baseband signal to an RF signal by the mixer 532, amplified by amplifiers 542-546, processed by the first transformer 596, and provided to the antenna for wireless transmission.

When the feedback signals/paths are used for DPD operations, transmission signals are adjusted or compensated to reduce distortion and non-linearity caused by transmit chain components, such as an amplifier or amplifiers thereof (e.g., a power amplifier thereof). In such DPD operations, a transmit signal is provided from the power amplifier of the transmit chain to a corresponding DPD circuit of or associated with the transmit chain and channel, such as DPD FE circuitry 586 or 588. The DPD FE circuitry 586 or 588 generates a DPD feedback signal which is routed to a baseband filter associated with a different channel of the wireless transceiver circuit 500.

The feedback signals are provided from the corresponding DPD circuit on the transmit chain to a receive baseband filter on a different receive chain by an inter-chain routing path. For example, the feedback signals are routed inter-chain in the RF region and then intra-chain in the BB region on the other channel. To illustrate, in the example of FIG. 5, the DPD FE circuitry 586 provides the DPD feedback signal to the mixer 538 of the second receive chain 518 via an inter-chain DPD feedback path. The DPD feedback signal may be provided to a digital baseband processor for DPD compensation after processing (e.g., filtering) by the receive baseband filter. After DPD compensations, a DPD compensated transmission signal (e.g., wireless transmission signal) is provided to the first transmit chain 512, processed by the first transmit chain 512, and output by an antenna coupled to the first transmit chain 512.

An example inter-chain routing path 599 is illustrated for the wireless transceiver circuit 500 of FIG. 5. The inter-chain routing path 599 includes an inter-chain RF portion and an inter-chain BB portion. To illustrate, the inter-chain routing path 599 provides feedback from a transmit chain sampling circuit or processing component (e.g., amplifier), which is the first DPD FE 586 in the DPD based example of FIG. 5, to the second receive chain 518 in a RF frequency range, before conversion to the baseband frequency range by the fourth mixer 538, and the downconverted baseband signal is also provided on the second receive chain 518 from the fourth mixer to the second receive baseband filter 528. As illustrated in FIG. 5, the inter-chain routing path 599 corresponds to the first channel 502 (the first transmit and receive chains 512 and 514). The wireless transceiver circuit 500 may have additional inter-chain routing paths, such as a second inter-chain routing path for the second channel 504 (the second transmit and receive chains 516 and 518).

Although the inter-chain routing paths in the example of FIG. 5 are illustrated from the first to the second chain and vice versa, in other examples, such as examples with additional chains, the inter-chain routing paths may be configured in many different ways. As illustrative, non-limiting examples, a first channel may provide inter-chain routing to a third channel, a fourth channel, an eighth channel, etc., and a second channel may provide inter-chain feedback to its own corresponding channel (e.g., any of receive chains 1-8), or to a dedicated channel for inter-chain routing.

As described above, the inter-chain design and routing operations of FIG. 5 are compatible with dedicated or shared baseband filter designs. However, the inter-chain routing design of FIG. 5 has a longer routing path than some other types of routing designs, such as the intra-chain routing design of FIG. 6.

FIG. 6 is a circuit diagram illustrating a wireless transceiver circuit 600 according to one or more aspects. The wireless transceiver circuit 600 may include or correspond to a wireless transceiver circuit 600 for intra-chain feedback signal routing. In some embodiments, portions of the RF transceiver of FIG. 6 may be located in a single integrated circuit (IC) sharing a common substrate, and each portion may be coupled to each other and to a PCB.

The wireless transceiver circuit 600 may include or correspond to a portion of a wireless transceiver circuit, such as a subset of channels of a larger transceiver. The wireless transceiver circuit 600 may include a plurality of channels, and in FIG. 6, components of two channels are illustrated for simplicity.

The wireless transceiver circuit 600 includes multiple bi-directional channels for wireless transmission and reception, including a first channel 602 and a second channel 604. Each channel may include at least a transmit chain and a receive chain. As illustrated in the example of FIG. 6, the first channel 602 includes a first transmit chain 612 and a first receive chain 614 and the second channel 604 includes a second transmit chain 616 and a second receive chain 618.

The wireless transceiver circuit 600 has a dedicated baseband filter architecture in the example of FIG. 6, and includes a first transmit baseband filter 622 for the first transmit chain 612 and a first receive baseband filter 624 for the first receive chain 614, a second transmit baseband filter 626 for the second transmit chain 616, and a second receive baseband filter 628 for the second receive chain 618. Each of the transmit chains 612 and 616 and each of the receive chains 614 and 618 may each include similar components as the transmit chains 512 and 516 and receive chains 514 and 518 of wireless transceiver circuit 500 of FIG. 5.

Each transmit chain 612 and 614 includes a corresponding mixer, amplifier, and DPD FE circuitry in the example of FIG. 6. For example, the first transmit chain 612 includes a first mixer 632, a first amplifier 646, and a first DPD FE circuitry 686, and the second transmit chain 616 includes a second mixer 636, a second amplifier 666, and a second DPD FE 688. In other examples, each transmit chain 612 and 614 may include a different transmit chain sampling circuit or processing component (e.g., amplifier), in addition to or in the alternative of the DPD FE circuitry, that is configured to generate transmit chain feedback for intra-chain feedback routing. Each transmit chain may optionally include additional processing or amplification circuitry, such as a differential amplifier (DA), a preamp (e.g., pre-PA), a transformer, or a combination thereof. For example, the first transmit chain 612 may include one or more of a first DA 642, a first pre-amplifier 644, or a first transformer 696, and the second transmit chain 616 may include one or more of a second DA 662, a second pre-amplifier 664, or a second transformer 698.

As illustrated in the example of FIG. 6, each transmit chain 612 and 614 includes an intra-chain path. For example, the first transmit chain 612 of the first channel 602 provides its feedback to the first receive chain 614 of the first channel 602, and the second transmit chain 616 of the second channel 604 provides its feedback to the second receive chain 618 of the second channel 604. The feedback is provided intra-chain (e.g., on the same channel) in a RF frequency range and is downconverted to a BB frequency range on the receive chain of the same channel. The intra-chain paths may include switches or other circuitry, such as first switch 692 and second switch 694, to provide isolation when the feedback path is not in use.

Each receive chain 614 and 618 includes a corresponding mixer and amplifier. For example, the first receive chain 614 includes a first mixer 634 and a first amplifier 654, and the second receive chain 618 includes a second mixer 638 and a second amplifier 674. Each receive chain 614 and 618 may optionally include one or more additional components. For example, each receive chain 614 and 618 may include additional amplifiers or processing circuitry. As illustrated in the example of FIG. 6, the first receive chain 614 includes a third amplifier 652 and the second receive chain 618 includes a fourth amplifier 672. In some aspects, the amplifiers of each chain may include or correspond to a two-stage amplifier. For example, the first and third amplifiers 652 and 654 may include or correspond to a two-stage amplifier or two-stage LNA, including a first cascode or LNA phase and a second GM phase.

In the example of FIG. 6, each channel may have a corresponding LO generation circuit to provide the input or LO signals for the mixers. For example, the first channel 602 includes first LO circuitry 682 configured to generate LO signals for the mixers 632 and 634 of the first channel 602, and the second channel 604 includes second LO circuitry 684 configured to generate LO signals for the mixers 636 and 638 of the second channel 604. The wireless transceiver circuit 600 may also be coupled to an antenna, such as antenna 410 of FIG. 4, and configured to receive RF energy received by the antenna and to provide RF energy to the antenna for transmission, as described with reference to FIGS. 4 and 5.

The wireless transceiver circuit 600 of FIG. 6 includes similar components to the wireless transceiver circuit 500 of FIG. 5. For example, the components of the transmit and receive chains of the wireless transceiver circuit 600 may be similar to or the same as the components of the transmit and receive chains of the wireless transceiver circuit 500 of FIG. 5. To illustrate, the baseband filters 622-628 may include or correspond to the baseband filters 522-528 of FIG. 5, the mixers 632-638 may include or correspond to the mixers 532-538 of FIG. 5, the amplifiers 642-674 may include or correspond to the amplifiers 542-574 of FIG. 5, the LO circuits 682 and 684 may include or correspond to the LO circuitry 582 and 584 of FIG. 5, the DPD FE circuitry 686 and 688 may include or correspond to the feedback circuitry 462 of FIG. 4 or the DPD FE circuitry 586 and 588 of FIG. 5, and the transformers 696 and 698 may include or correspond to the transformers 596 and 598 of FIG. 5.

During operation, the wireless transceiver circuit 600 of FIG. 6 may operate similar to the wireless transceiver circuit 500 of FIG. 5. For example, the wireless transceiver circuit 600 of FIG. 6 may receive and transmit wireless signals as described with reference to FIGS. 4 and 5. Additionally, the wireless transceiver circuit 600 of FIG. 6 may engage in DPD operations or other feedback driven operations as described with reference to FIGS. 4 and 5, with intra-chain routing, as opposed to the inter-chain routing of the wireless transceiver circuit 500 of FIG. 5.

During operation, the wireless transceiver circuit 600 may receive wireless signals on one or more channels. For example, the wireless transceiver circuit 600 may receive a wireless signal on the first receive chain 614, the second receive chain 618, or both. Wireless signals are received via one or more corresponding antennas and provided to a corresponding receive chain. Wireless signals on the receive chains 614 and 618 are processed by the components thereof and provided to the corresponding dedicated receive baseband filter, one of first receive baseband filter 624 or second receive baseband filter 628. The wireless signals are provided from the corresponding mixer on the receive chain to the corresponding dedicated receive baseband filter on the receive chain.

During operation, the wireless transceiver circuit 600 may transmit wireless signals on one or more channels. For example, the wireless transceiver circuit 600 may transmit a wireless signal on the first transmit chain 612, the second transmit chain 616, or both. Wireless signals are generated by a baseband processor (not shown), provided to a corresponding transmit chain, and transmitted via one or more corresponding antennas (not shown). Wireless signals on the transmit chains 612 and 616 are processed by the components thereof and provided to the antenna for transmission.

When the feedback signals/paths are used for DPD operations, transmission signals may be adjusted or compensated to reduce distortion and non-linearity caused by transmit chain components, such as an amplifier or amplifiers thereof (e.g., a power amplifier thereof). In such DPD operations, a transmit signal is provided from the power amplifier of the transmit chain to a corresponding DPD circuit of or associated with the transmit chain and channel, such as DPD FE circuitry 686 or 688. The DPD FE circuitry 686 or 688 generates a DPD feedback signal which is routed back to a corresponding receive baseband filter of the wireless transceiver circuit 600.

The feedback signals are provided from the corresponding DPD FE circuit on the transmit chain to a receive baseband filter on a corresponding receive chain of the same channel by an intra-chain routing path. For example, the feedback signals are routed intra-chain in the RF and BB regions. To illustrate, for first channel 602 operations, the DPD FE circuitry 686 generates and provides the feedback signal to the mixer 634 of the first receive chain 614. The feedback signals may be routed intra-chain as each chain of the channel has its own dedicated baseband filter. The feedback signal may be provided to a digital baseband processor for DPD compensation after processing (e.g., filtering) by the receive baseband filter. After DPD compensation, a DPD compensated transmission signal (e.g., wireless transmission signal) is provided to the first transmit chain 612, processed by the first transmit chain 612, and output by an antenna coupled to the first transmit chain 612.

An example intra-chain routing path 699 is illustrated for the wireless transceiver circuit 600 of FIG. 6. The intra-chain routing path 699 includes an intra-chain RF portion and an intra-chain BB portions. To illustrate, the intra-chain routing path 699 provides feedback from the first DPD FE 686 (or other transmit chain feedback or sampling circuitry) to the first receive chain 614 in a RF frequency range, before conversion to the baseband frequency range by the second mixer 634, and the downconverted baseband signal is also provided on the first receive chain 614 from the second mixer 634 to the first receive baseband filter 624. As illustrated in FIG. 6, the intra-chain routing path 699 corresponds to the first channel 602 (the first transmit and receive chains 612 and 614). The wireless transceiver circuit 600 may have additional intra-chain routing paths, such as a second intra-chain routing path for the second channel 604 (the second transmit and receive chains 616 and 618).

As compared to the inter-chain routing of FIG. 5, the intra-chain DPD routing of FIG. 6 is shorter, and specifically is shorter in the RF region (e.g., for signals in the RF frequency range and before downconversion to baseband frequencies by a mixer). The shorter distance reduces unwanted coupling and interference and requires less space and power. Thus, the transceiver has improved performed for feedback reliant operations and reduced size for feedback routing as compared to inter-chain routing, such as in FIG. 5. However, the inter-chain routing of FIG. 5 enables reduced component duplication which reduces transceiver size (e.g., reduced baseband filters) and power consumption for transmit and receive operations.

Because of these competing benefits and drawbacks, neither of the current inter-chain feedback routing and intra-chain feedback routing offers improved performance and reduced area and power consumption for advanced transceiver designs. In the aspects described herein, hybrid feedback routing designs are described to provide improved performance and reduced area and power consumption for advanced transceiver designs, including for transmit, receive, and DPD or other operations reliant on feedback path measurements.

FIG. 7 is a circuit diagram illustrating a wireless transceiver circuit 700 according to one or more aspects. The wireless transceiver circuit 700 may include or correspond to a wireless transceiver circuit 700 for hybrid and configurable feedback routing. In some embodiments, portions of the RF transceiver of FIG. 7 may be located in a single integrated circuit (IC) sharing a common substrate, and each portion may be coupled to each other and to a PCB.

As compared to the wireless transceiver circuits 500 and 600 of FIGS. 5 and 6, which include dedicated baseband filters for corresponding transmit and receive chains of the same channel, the wireless transceiver circuit 700 of FIG. 7 includes shared baseband filters for each transmit and receive chain of a channel, such as shared baseband filters 722 and 724. In prior shared baseband filters transceiver designs, inter-chain feedback was required because the shared baseband filter is already in use by the transmit chain and cannot be also used by a corresponding receive chain to receive the feedback. However, in the hybrid designs hereof, intra-chain routing is used in the RF portion and configurable inter-or intra-chain routing is used in the RF portion to enable at least partial intra-chain routing even in shared baseband filter transceiver architectures.

Additionally, the wireless transceiver circuit 700 of FIG. 7 includes similar components to the wireless transceiver circuits 500 and 600 of FIGS. 5 and 6. As compared to the inter-chain routing for feedback of the wireless transceiver circuit 500 of FIG. 5 and to the intra-chain routing for feedback of the wireless transceiver circuit 600 of FIG. 6, the wireless transceiver circuit 700 of FIG. 7 includes a configurable and hybrid routing scheme for feedback including both inter-chain routing and intra-chain routing. Additionally, the hybrid routing scheme for feedback utilizes intra-chain RF routing even when utilizing inter-chain routing. The selectable/configurable inter or intra-chain routing occurs in the baseband signal portion to improve transceiver performance, including reduced coupling and power consumption.

The wireless transceiver circuit 700 may include or correspond to a portion of a wireless transceiver circuit, such as a subset of channels of a larger transceiver. The wireless transceiver circuit 700 may include a plurality of channels, and in FIG. 7, components of two channels are illustrated for simplicity.

The wireless transceiver circuit 700 includes multiple bi-directional channels for wireless transmission and reception, including a first channel 702 and a second channel 704. Each channel 702 and 704 may include one or more chains, such as first transmit chain 712 and first receive chain 714 of first channel 702 and second transmit chain 718 and second receive chain 716 of second channel 704.

Although the example FIG. 7 is directed to an example with pairs of chains and a channel including a transmit chain (TX) and a receive (RX) chain, in other implementations the wireless transceiver circuit 700 may also include one or more feedback receive (FBRX) chains which have similar or identical operation to the receive chains 714 and 716. In some such implementations, a channel may have three chains, such as TX chain, an RX chain and a FBRX chain.

Each transmit chain 712 and 714 includes a corresponding mixer, amplifier, and DPD FE circuitry in the example of FIG. 7. For example, the first transmit chain 712 includes a first mixer 732, a first amplifier 746, and a first DPD FE circuitry 786, and the second transmit chain 716 includes a mixer 736, a second amplifier 766, and a second DPD FE circuitry 788. In other examples, each transmit chain 712 and 714 may include a different transmit chain sampling circuit or processing component (e.g., amplifier), in addition to or in the alternative of the DPD FE circuitry, that is configured to generate transmit chain feedback for intra-chain feedback routing. Each transmit chain may optionally include additional processing or amplification circuitry, such as a differential amplifier (DA), a preamp (e.g., pre-PA), a transformer, or a combination thereof. For example, the first transmit chain 712 may include one or more of a first DA 742, a first pre-amplifier 744, or a first transformer 796, and the second transmit chain 716 may include one or more of a second DA 762, a second pre-amplifier 764, or a second transformer 798.

Each receive chain 714 and 718 includes a corresponding mixer and amplifier. For example, the first receive chain 714 includes a mixer 734 and a first amplifier 754, and the second receive chain 718 includes a second mixer 738 and a second amplifier 774. Each receive chain 714 and 718 may optionally include one or more additional components. For example, each receive chain 714 and 718 may include additional amplifiers or processing circuitry. As illustrated in the example of FIG. 7, the first receive chain 714 includes a third amplifier 752 and the second receive chain 718 includes a fourth amplifier 772. In some aspects, the amplifiers of each chain may include or correspond to a two-stage amplifier. For example, the first and third amplifiers 752 and 754 may include or correspond to a two-stage amplifier or two-stage LNA, including a first cascode or LNA phase and a second GM phase.

In the example of FIG. 7, each channel may have a corresponding LO generation circuit to provide the input or LO signals for the mixers. For example, the first channel 702 includes first LO circuitry 782 configured to generate LO signals for the mixers 732 and 734 of the first channel 702, and the second channel 704 includes second LO circuitry 784 configured to generate LO signals for the mixers 736 and 738 of the second channel 704. The wireless transceiver circuit 700 may also be coupled to an antenna, such as antenna 410 of FIG. 4, and configured to receive RF energy received by the antenna and to provide RF energy to the antenna for transmission, as described with reference to FIGS. 4-6.

The wireless transceiver circuit 700 of FIG. 7 includes similar components to any of the wireless transceiver circuits of FIGS. 4-6. For example, the components of the transmit and receive chains of the wireless transceiver circuit 700 may be similar to or the same as the components of the transmit and receive chains of the wireless transceiver circuits 500 or 600 of FIGS. 5 and 6. To illustrate, the shared baseband filters 722-724 may include or correspond to the baseband filters 522-528 of FIG. 5, the mixers 732-738 may include or correspond to the mixers 532-538 of FIG. 5, the amplifiers 742-774 may include or correspond to the amplifiers 542-574 of FIG. 5, the LO circuits 782 and 784 may include or correspond to the LO circuitry 582 and 584 of FIG. 5, the DPD FE circuitry 786 and 788 may include or correspond to the feedback circuitry 462 of FIG. 4, the DPD FE circuitry 586 and 588 of FIG. 5, or the DPD FE circuitry 686 and 688 of FIG. 6, and the transformers 796 and 798 may include or correspond to the transformers 596 and 598 of FIG. 5.

The wireless transceiver circuit 700 includes routing circuitry 726 coupled to receive chains 714 and 716 of each of the first and second channels 702 and 704. Specifically, the routing circuitry 726 has corresponding inputs coupled to outputs of the receive mixers 734 and 736 and has corresponding outputs coupled to inputs of the first and second shared baseband filters 722 and 724.

The routing circuitry 726 is configured to provide flexible routing of receive signals and feedback signals inter-chain or intra-chain in the baseband frequency range. To illustrate, the routing circuitry 726 is placed downstream of the receive mixers 734 and 736 (e.g., downconverters) which mix a received LO signal with a received wireless signal or DPD feedback signal to downconvert the signal from a RF frequency range to a baseband frequency range. The routing circuitry 726 may be configured to provide both intra-chain paths and inter-chain paths for each receive chain. For example, the routing circuitry 726 can be switched from providing a path from a mixer of a receive chain to a baseband filter of the receive chain or to another path from the mixer of the receive chain to another baseband filter of another receive chain.

The routing circuitry 726 may be controlled by an integrated controller or a separate controller (not shown in FIG. 7). The controller may be part of a transceiver controller or baseband processor, as described with reference to FIGS. 3 and 4. The routing circuitry 726 includes a plurality of selectable or configurable routing paths between each of the mixers and baseband filters, as described further with reference to FIGS. 8-10C, to provide inter-chain or intra-chain routing for receive and feedback signal. In some aspects, the routing circuitry 726 includes one or more switches or other components which can be activated or adjusted to provide or switch paths, as further described with reference to FIG. 8.

As illustrated in the example of FIG. 7, each channel 702 and 704 includes an intra-chain portion of the hybrid path from a DPD FE circuit (or another feedback or sampling circuit) of a transmit chain to a mixer of a corresponding receive chain on the same channel. For example, the first DPD FE circuitry 786 of the first transmit chain 712 of the first channel 702 provides its feedback to the mixer 734 of the first receive chain 714 of the first channel 702 intra-chain, and the second DPD FE circuitry 788 of the second transmit chain 716 of the second channel 704 provides its feedback to the mixer 736 of the second receive chain 718 of the second channel 704. The feedback is provided intra-chain (e.g., within a same channel) in a RF frequency range and is downconverted to a BB frequency range on the receive chain of the same channel. The intra-chain paths may include switches or other circuitry, such as first switch 592 and second switch 594, to provide isolation when feedback is not in use. After the feedback signal is downconverted (on the same chain), the feedback signal is provided to the routing circuitry 726 for either inter-chain or intra-chain routing in the baseband region by the routing circuitry 726. The intra-chain paths may include switches or other circuitry, such as first switch 792 and second switch 794, to provide isolation when feedback is not in use.

As compared to the inter-chain feedback routing of FIG. 5, the hybrid routing of FIG. 7 is shorter, and specifically is shorter in the RF region as the feedback is provided intra-chain in the RF region. As compared to the intra-chain routing of FIG. 6, the hybrid routing of FIG. 7 is marginally longer only when using inter-chain BB routing. However, the hybrid routing of FIG. 7 offers improved flexibility and compatibility with advanced, reduced component transceiver designs, such as shared baseband filter transceiver designs.

During operation, the wireless transceiver circuit 700 may receive wireless signals on one or more channels. For example, the wireless transceiver circuit 700 may receive a wireless signal on the first receive chain 714, the second receive chain 716, or both. Wireless signals are received via one or more corresponding antennas and provided to a corresponding receive chain. Wireless signals on the receive chains 714 and 716 are processed by the components thereof and provided to the corresponding shared baseband filter, one of first shared baseband filter 722 or second shared baseband filter 724. The wireless signals are provided from the corresponding mixer on the receive chain to the corresponding shared baseband filter on the receive chain by the routing circuitry 726. For example, the routing circuitry 726 routes received wireless signals intra-chain.

During operation, the wireless transceiver circuit 700 may transmit wireless signals on one or more channels. For example, the wireless transceiver circuit 700 may transmit a wireless signal on the first transmit chain 712, the second transmit chain 718, or both. Wireless signals are generated by a baseband processor (not shown), provided to a corresponding transmit chain and transmitted via one or more corresponding antennas (not shown). Wireless signals on the transmit chains 712 and 718 are processed by the components thereof and provided to the antenna for transmission.

When the feedback signal/paths are used for DPD operations, transmission signals may be adjusted or compensated to reduce distortion and non-linearity caused by transmit chain components, such as an amplifier or amplifiers thereof (e.g., a power amplifier thereof). In such DPD operations, a transmit signal is provided from the power amplifier to a corresponding DPD circuit, such as DPD FE circuitry 786 or 788. The DPD FE circuitry generates a DPD feedback signal which is routed back to a baseband filter of the wireless transceiver circuit 700.

The feedback signals are provided from the corresponding mixer on the receive chain to another shared baseband filter on a different receive chain by the routing circuitry 726. For example, the routing circuitry 726 routes feedback signals inter-chain. To illustrate, the feedback signals are routed inter-chain as the shared baseband filter 722 for the first receive chain 714 is already in use by the first transmit chain 712. The feedback signal may be provided to a digital baseband processor for processing and adjustment, e.g., DPD compensation. After DPD compensation, a DPD compensated transmission signal (e.g., wireless transmission signal) is provided to the first transmit chain 712, processed by the first transmit chain 712, and output by an antenna coupled to the first transmit chain 712.

An example hybrid feedback routing path 799 is illustrated for the wireless transceiver circuit 700 of FIG. 7. The hybrid feedback routing path 799 includes an intra-chain RF portion and two configurable or selectable BB routing portions or paths, an intra-chain path 799a and an inter-chain path 799b, through the routing circuitry 726. As illustrated in FIG. 7, the hybrid feedback routing path 799 corresponds to the first channel 702 (the first transmit and receive chains 712 and 714). The wireless transceiver circuit 700 may have additional hybrid feedback routing paths, such as a second hybrid feedback routing path for the second channel 704 (the second transmit and receive chains 716 and 718).

Although the hybrid feedback routing paths in the example of FIG. 7 are illustrated from the first to the second chain and vice versa, in other examples, such as examples with additional chains, the hybrid feedback routing paths (e.g., the inter-chain path or paths thereof) may be configured in many different ways. As illustrative, non-limiting examples, a first channel may provide inter-chain feedback routing to one or more of a second channel, a third channel, a fourth channel, an eighth channel, etc., and a second channel may provide inter-chain routing to its own corresponding channel or channels (e.g., one or more of any of receive chains 1-8), or to a dedicated channel for hybrid feedback routing.

Thus, the wireless transceiver circuit 700 of FIG. 7 may have configurable routing circuitry that enables the wireless transceiver circuit 700 to switch between intra-chain routing for received wireless signals and inter-chain routing for feedback signals to enable shorter feedback routing and better performance as compared to wireless transceiver circuit 500 of FIG. 5. Additionally, the wireless transceiver circuit 700 of FIG. 7 has additional compatibility as compared to the wireless transceiver circuit 600 of FIG. 6, because the wireless transceiver circuit 700 of FIG. 7 is capable of being used with shared component designs for channels of the transceiver, such as shared baseband filter or processor designs.

FIG. 8 is a circuit diagram illustrating a wireless transceiver circuit 800 according to one or more aspects. The wireless transceiver circuit 800 may include or correspond to a wireless transceiver circuit 800 for hybrid and configurable feedback routing. In some embodiments, portions of the RF transceiver of FIG. 8 may be located in a single integrated circuit (IC) sharing a common substrate, and each portion may be coupled to each other and to a PCB.

The wireless transceiver circuit 800 may include or correspond to a portion of a wireless transceiver circuit, such as a subset of channels of a larger transceiver. The wireless transceiver circuit 800 may include a plurality of channels, and in FIG. 8, components of two channels are illustrated for simplicity.

As illustrated in the example of FIG. 8, the wireless transceiver circuit 800 may include the same or similar components as the wireless transceiver circuit 700 of FIG. 7. As compared to the wireless transceiver circuit 700, the wireless transceiver circuit 800 of FIG. 8 includes an illustrative example of the routing circuitry 726 of FIG. 7, that is routing circuitry 802.

The routing circuitry 802 is configured to provide flexible routing of receive signals and feedback signals inter-chain or intra-chain in baseband frequency range. To illustrate, the routing circuitry 802 is place downstream of the receive mixers 734 and 736 (e.g., downconverters) which mix a received LO signal with a received wireless signal or feedback signal to downconvert the signal from a RF frequency range to a baseband frequency range. The routing circuitry 802 may be configured to provide both intra-chain paths and inter-chain paths for each receive chain. For example, the routing circuitry 802 can be switched from providing a path from a mixer of a receive chain to a baseband filter of the receive chain or to another baseband filter of another receive chain.

The routing circuitry 802 may controlled by an integrated controller or a separate controller (not shown in FIG. 8). The controller may be part of a transceiver controller or baseband processor, as described with reference to FIGS. 3 and 4.

In the example of FIG. 8, the routing circuitry 802 includes a plurality of switches 812-828, including a first switch 812, a second switch 814, a third switch 816, a fourth switch 818, a fifth switch 822, a sixth switch 824, a seventh switch 826, and an eighth switch 828. The first switch 812 is coupled to the second switch 814, the third switch 816, the mixer 734, and the first shared baseband filter 722. The second switch 814 is coupled to the first switch 812, the third switch 816, the fourth switch 818, the fifth switch 822, the seventh switch 826, and the eighth switch 828. The third switch 816 is coupled to the mixer 734 (e.g., a first receive mixer or downconverter), the first switch 812, the second switch 814, the fourth switch 818, the fifth switch 822, the seventh switch 826, and the eighth switch 828. The fourth switch 818 is coupled to the second switch 814, the third switch 816, the fifth switch 822, the seventh switch 826, the eighth switch, and ground.

The fifth switch 822 is coupled to the second switch 814, the third switch 816, the fourth switch 818, the sixth switch 824, the seventh switch 826, and the eighth switch 828. The sixth switch 824 is coupled to the second mixer, the second shared baseband filter 724, the fifth switch 822, and the seventh switch 826. The seventh switch 826 is coupled to the second mixer, the second switch 814, the third switch 816, the fourth switch 818, the fifth switch 822, the sixth switch 824, and the eighth switch 828. The eighth switch 828 is coupled to the second switch 814, the third switch 816, the fifth switch 822, the seventh switch 826, and ground.

In the example illustrated in FIG. 8, the first switch 812 has an input terminal coupled to the mixer 734 and an input terminal of the third switch 816, and has an output terminal coupled to an input terminal of the first shared baseband filter 722 and to an input terminal of the second switch 814. The second switch 814 has an output terminal coupled to an input terminal of the fourth switch 818 and an output terminal of the third switch 816.

The third switch 816 has an input terminal coupled to the output terminal of the mixer 734 and an output terminal coupled to the input terminal of the fourth switch 818, an input terminal of the fifth switch 822, an input terminal of the seventh switch 826 and an input terminal of the eighth switch 828. The fourth switch 818 has an output terminal coupled to ground.

The fifth switch 822 has the input terminal coupled to the input terminal of the eighth switch 828 and has an output terminal coupled to an input terminal of the second shared baseband filter 724 and to an output terminal of the sixth switch 824. The sixth switch 824 has the output terminal coupled to the second shared baseband filter 724 and an input terminal coupled to an output terminal of the mixer 736. The seventh switch 826 has an output terminal coupled to the output terminal of the mixer 736. The eighth switch 828 has an output terminal coupled to ground.

The plurality of switches 812-828 are configured to be controlled or switch to provide the different intra-chain or inter-chain paths during receive operations and transmit DPD operations. For example, the first switch 812 may be configured to be enabled (e.g., active or closed) in a receive mode for the first channel 702 and for DPD mode operations with intra-chain BB routing. The first switch 812 may be configured to be disabled (e.g., inactive or open) in other modes, such as transmit modes for either channel, intra-chain modes for the second channel 704, inter-chain modes for either channel, and/or receive modes for the second channel 704.

The sixth switch 824 may be configured to be enabled in a receive mode for the second channel 704 and for DPD mode operations with intra-chain BB routing. The sixth switch 824 may be configured to be disabled in other modes, such as transmit modes for either channel, intra-chain modes for the first channel 702, inter-chain modes for either channel, and/or receive modes for the first channel 702.

The second and seventh switches 814 and 826 may be configured to be enabled for DPD mode operations with intra-chain BB routing from the first channel 702 to the second channel 704 (e.g., first channel 702 transmission with DPD). The third and fifth switches 816 and 822 may be configured to be enabled for DPD mode operations with intra-chain BB routing from the second channel 704 to the first channel 702 (e.g., second channel 704 transmission with DPD).

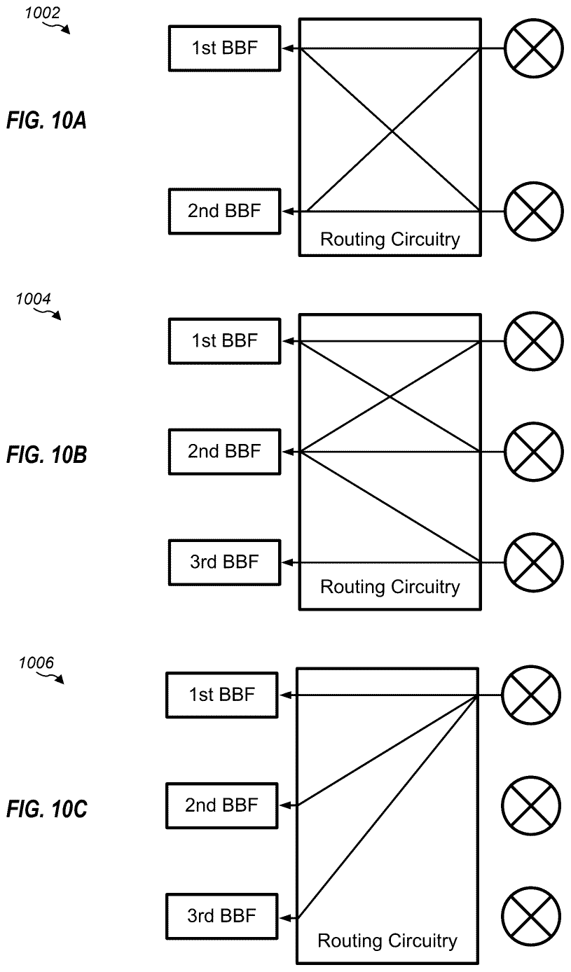

The fourth and eighth switches 818 and 828 may be configured to be enabled for receive mode operations for the first channel 702 and the second channel 704. Although the switches 812-828 have been described as having “input” terminals and “output” terminals, this is for convention only and the naming convention of terminals of the switches 812-828 as described may not relate to their functionality in all routing cases. For example, an input terminal of a particular switch may receive a signal in some routing or operational modes and may output a signal in some other routing or operational modes. The terminals of the switches 812-828 may be referred to as first and second terminals. The specific example of the routing circuitry 802 (e.g., the placement and number of switches) in the example of FIG. 8 may correspond to a specific baseband frequency or frequency range and a single inter-chain path. In other examples, the routing circuitry 802 may have a different layout with different switches and/or inter-chain routing paths, and such may correspond to circuits with different numbers of chains and/or different baseband frequencies. Other examples of routing circuitry 802 are described further with reference to FIGS. 10A-10C.

During operation, the wireless transceiver circuit 800 of FIG. 8 may operate similar to the wireless transceiver circuit 700 of FIG. 7. For example, the wireless transceiver circuit 800 of FIG. 8 may receive and transmit wireless signals as described with reference to FIG. 7. Additionally, the wireless transceiver circuit 800 of FIG. 8 may engage in DPD operations as described with reference to FIG. 7. As compared to the wireless transceiver circuit 700 of FIG. 7, which includes routing circuitry 726, the wireless transceiver circuit 800 of FIG. 8 includes routing circuitry 802.

During operation and intra-chain routing, such as wireless signal reception, the wireless transceiver circuit 800 may configure the routing circuitry 802 to form one or more intra-chain routing paths. For example, a digital baseband process or controller (e.g., routing circuitry controller) may adjust (e.g., open or close) switches 812-828 of the routing circuitry 802 to form one or more intra-chain routing paths. To illustrate, when receiving on the first receive chain 714 on the first channel 702, the first switch 812 may be enabled (e.g., active or closed) to provide a path from the mixer 734 to the first shared baseband filter 722. In some aspects, the fourth and eighth switches 818 and 828 may also be enabled (e.g., active or closed) to ground any unused inter-chain routing paths. Additionally, the other switches, such as switches 814, 816, 822, 824, and 826 may be disabled (e.g., inactive or open).

During reception of the first receive chain 714 of the first channel 702, other first chain components may be powered off. For example, the amplifiers of the first receive chain 714 may be powered down. Similarly, the wireless transceiver circuit 800 can receive wireless signals on the second receive chain 704, concurrently with wireless signals on the first receive chain 702 or at anther time. In such aspects, the sixth switch 824 may be enabled (e.g., active or closed) to provide a path from the mixer 736 to the second shared baseband filter 724.

During operation and inter-chain routing, such as transmission or DPD operation, the wireless transceiver circuit 800 may configure the routing circuitry 802 to form one or more inter-chain routing paths. For example, a digital baseband process or controller (e.g., routing circuitry controller) may adjust (e.g., open or close) switches 812-828 of the routing circuitry 802 to form one or more inter-chain routing paths. To illustrate, when transmitting on the first receive chain 714 on the first channel 702, the third and fifth switches 816 and 822 may be enabled (e.g., active or closed) to provide a path from the mixer 734 (of the first receive chain 714 of the first channel 702) to the second shared baseband filter 724 of the second channel 704. In some aspects, the first and sixth switches 812 and 824 may be disabled (e.g., inactive or open) to provide isolation from transmission leaking and/or to reduce or eliminate parasitic loading of the mixer 736 of the second receive chain 716 of the second channel 704. Additionally, the other switches, such as second and seventh switches 814 and 826 may be disabled (e.g., inactive or open).

During transmission on the first transmit chain 712 of the first channel 702, other first receive chain components may be powered off. For example, the amplifiers 752 and 754 of the first receive chain 714 and the second receive chain 716 may be powered down. Similarly, the wireless transceiver circuit 800 can transmit wireless signal on the second transmit chain 718, concurrently with wireless signals on the first transmit chain 712 or at anther time. In such aspects where the transceiver transmits on the second transmit chain 718, the second and seventh switches 814 and 826 may be enabled (e.g., active or closed) to provide a path from the mixer 736 to the second shared baseband filter 724.

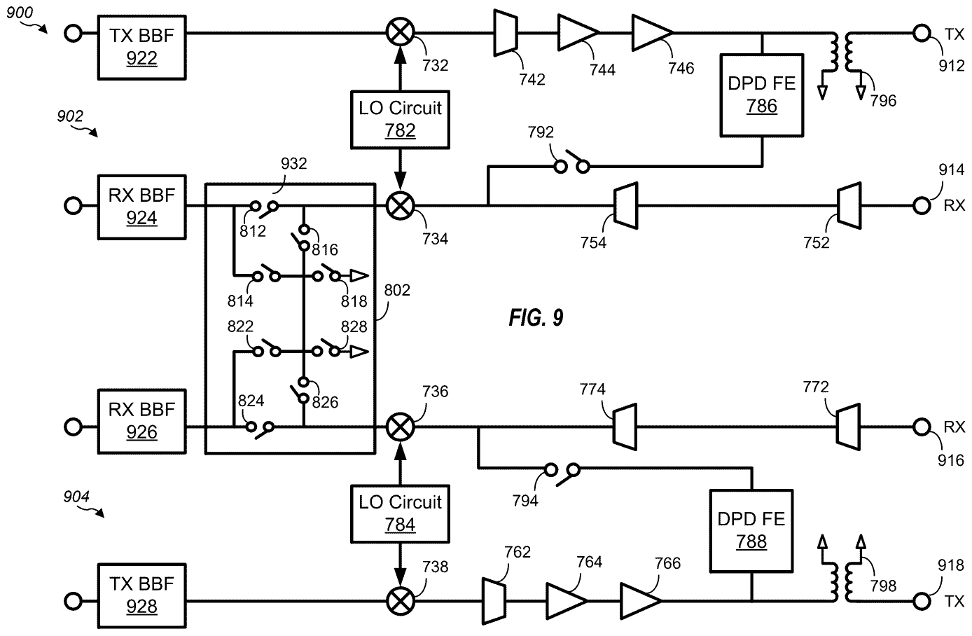

Accordingly, hybrid DPD routing as described in FIGS. 7 and 8 provides operational benefits for transceivers as compared to inter-or intra-chain only routing and is compatible with shared baseband filter designs. Although, hybrid DPD routing is illustrated with shared baseband filter designs in the examples of FIGS. 7 and 8, hybrid DPD routing is also compatible with other transceiver designs, such as dedicated baseband filter designs as illustrated and described with reference to FIG. 9.

FIG. 9 is a circuit diagram illustrating a wireless transceiver circuit 900 according to one or more aspects. The wireless transceiver circuit 900 may include or correspond to a wireless transceiver circuit 800 for hybrid and configurable feedback routing. In some embodiments, portions of the RF transceiver of FIG. 9 may be located in a single integrated circuit (IC) sharing a common substrate, and each portion may be coupled to each other and to a PCB.

The wireless transceiver circuit 900 may include or correspond to a portion of a wireless transceiver circuit, such as a subset of channels of a larger transceiver. The wireless transceiver circuit 900 may include a plurality of channels, and in FIG. 9, components of two channels are illustrated for simplicity.

As illustrated in the example of FIG. 9, the wireless transceiver circuit 900 may include the same or similar components as the wireless transceiver circuits 700 or 800 of FIGS. 7 and 8. As compared to the wireless transceiver circuits 700 and 800 of FIGS. 7 and 8, which includes shared baseband filters for corresponding transmit and receive chains of the same channel, the wireless transceiver circuit 900 of FIG. 9 includes dedicated baseband filters for each transmit and receive chain of a channel. The hybrid routing designs and operations described with reference to FIGS. 7 and 8, are also applicable to dedicated baseband filters as in FIG. 9.

The wireless transceiver circuit 900 includes multiple bi-directional channels for wireless transmission and reception, including a first channel 902 and a second channel 904. Each channel may include at least a transmit chain and a receive chain. As illustrated in the example of FIG. 9, the first channel 902 includes a first transmit chain 912 and a first receive chain 914 and the second channel 904 includes a second transmit chain 918 and a second receive chain 916.

The transceiver 900 has a dedicated baseband filter architecture in the example of FIG. 9, and includes a first transmit baseband filter 922 for the first transmit chain 912 and a first receive baseband filter 924 for the first receive chain 914, a second receive baseband filter 926 for the second receive chain 916, and a second transmit baseband filter 928 for the second transmit chain 918. Each of the transmit chains 912 and 918 and each of the receive chains 914 and 916 may each include similar components as the transmit chains 712 and 718 and receive chains 714 and 716 of the wireless transceiver circuits 700 or 800 of FIGS. 7 and 8.

During operation, the wireless transceiver circuit 900 of FIG. 9 may operate similar to the wireless transceiver circuits 700 and 800 of FIGS. 7 and 8. For example, the wireless transceiver circuit 900 of FIG. 9 may receive and transmit wireless signals as described with reference to FIGS. 7 and 8. Additionally, the wireless transceiver circuit 900 of FIG. 9 may engage in DPD operations as described with reference to FIGS. 7 and 8.

During operation and intra-chain routing, such as wireless signal reception, the wireless transceiver circuit 900 may configure the routing circuitry 802 to form one or more intra-chain routing paths. For example, a digital baseband process or controller (e.g., routing circuitry controller) may adjust (e.g., open or close) switches 812-828 of the routing circuitry 802 to form one or more intra-chain routing paths. To illustrate, when receiving on the first receive chain 914 on the first channel 902, the first switch 812 may be enabled (e.g., active or closed) to provide a path (e.g., first intra-chain path for the first channel 902) from the mixer 734 to the first receive baseband filter 924. In some aspects, the fourth and eighth switches 818 and 828 may also be enabled (e.g., active or closed) to ground any unused inter-chain routing paths. Additionally, the other switches, such as switches 814, 816, 822, 824, and 826, may be disabled (e.g., inactive or open) to provide isolation or unwanted coupling.

During reception of the first receive chain 914 of the first channel 902, other first chain components may be powered off. For example, the amplifiers 752 and 754 of the first receive chain 914 may be powered down. Similarly, the wireless transceiver circuit 900 can receive wireless signals on the second receive chain 916, concurrently with wireless signals on the first receive chain 914 or at anther time. In such aspects, the sixth switch 824 may be enabled (e.g., active or closed) to provide a path (e.g., second intra-chain path for the second channel 904) from the mixer 736 to the second receive baseband filter 926.

During operation and inter-chain routing, such as transmission or DPD operation, the wireless transceiver circuit 900 may configure the routing circuitry 802 to form one or more inter-chain routing paths. For example, a digital baseband process or controller (e.g., routing circuitry controller) may adjust (e.g., open or close) switches 812-828 of the routing circuitry 802 to form one or more inter-chain routing paths. To illustrate, when transmitting on the first receive chain 914 on the first channel 902, the third and fifth switches 816 and 822 may be enabled (e.g., active or closed) to provide a path (e.g., first inter-chain path from the first channel 902 to the second channel 904) from the mixer 734 (of the first receive chain 914 of the first channel 902) to the second receive baseband filter 926 of the second channel 904. In some aspects, the first and sixth switches 812 and 824 may be disabled (e.g., inactive or open) to provide isolation from transmission leaking and/or to reduce or eliminate parasitic loading of the mixer 736 of the second receive chain 916 of the second channel 904. Additionally, the other switches, such as second and seventh switches 814 and 826 may be disabled (e.g., inactive or open).

During transmission on the first transmit chain 912 of the first channel 902, other first receive chain 914 components may be powered off. For example, the amplifiers 752 and 754 of the first receive chain 914 and the amplifiers 772 and 774 the second receive chain 916 may be powered down. Similarly, the wireless transceiver circuit 900 can transmit wireless signal on the second transmit chain 918, concurrently with wireless signals on the first transmit chain 912 or at anther time. In such aspects, the second and seventh switches 814 and 826 may be enabled (e.g., active or closed) to provide a path (e.g., second inter-chain path from the second channel 904 to the first channel 902) from the mixer 736 to the first receive baseband filter 924.

Thus, the wireless transceiver circuit 900 of FIG. 9 has dedicated baseband filters and configurable routing circuitry that enables the wireless transceiver circuit 900 to also switch between intra-chain routing and inter-chain routing for feedback signals to enable more flexible feedback routing, including fully intra-chain feedback routing which reduces feedback path length even as compared to the wireless transceiver circuit 700 of FIG. 7. The reduced feedback path length may enable improved wireless performance from reduced coupling and power consumption.

Although not shown in FIGS. 7-9, the circuitry of the receive and transmit chains may include bypass circuitry to enable DPD signals and/or other feedback signals to bypass some components and processing thereof. For example, receive chains which receive feedback may include bypass circuitry from one or more components thereof, such as amplifiers thereof. This may enable the feedback to pass through the receive chain without additional or unwanted processing (e.g., extra amplification and distortion). Additionally, this enables flexibility in where the DPD FE circuitry provides the feedback to and possibly a shorter or less complex intra-chain or inter-chain path. To illustrate, the feedback may be provided to the receive chain upstream of an amplifier (or bypass circuitry associated therewith) of the receive chain instead of to the mixer of the receive chain directly.

FIG. 10A-10C correspond to block diagrams of exemplary routing circuitry. For example, 10A-10C each illustrate one example of a routing circuit described herein, such as the routing circuitry of FIGS. 7-9, which can provide transmit chain feedback to a baseband processor via two or more selectable receive chains. The transmit chain feedback may include RF region generated or routed feedback and/or power amplifier generated or based feedback, such as DPD feedback, calibration feedback, error correction feedback, and the like.

FIG. 10A corresponds to a block diagram illustrating routing circuitry for two receive chains with four routing paths, first routing circuitry 1002. The first routing circuitry 1002 for two receive chains includes two paths for each mixer. For example, one path from the mixer to a corresponding baseband filter on the same receive chain (e.g., inter-chain), and another path from the mixer to another baseband filter on a different receive chain (e.g., intra-chain). To illustrate, the first routing circuitry 1002 includes a first routing path from the first mixer of the first receive chain to the first baseband filter of the first receive chain and a second routing path from the first mixer of the first receive chain to the second baseband filter of the second receive chain. The first routing circuitry 1002 also includes two routing paths for the second mixer, such as a third routing path from a second mixer of the second receive chain to the second baseband filter of the second receive chain, and a fourth routing path from the second mixer of the second receive chain to the first baseband filter of the first receive chain.

FIG. 10B corresponds to a block diagram illustrating routing circuitry for more than two receive chain, second routing circuitry 1004. The second routing circuitry 1004 includes two paths for each mixer of the three mixers. For example, one path from the mixer to a corresponding baseband filter on the same receive chain (e.g., inter-chain), and another path from the mixer to another baseband filter on a different receive chain (e.g., intra-chain). To illustrate, the second routing circuitry 1004 includes a first routing path from the first mixer of the first receive chain to the first baseband filter of the first receive chain and a second routing path from the first mixer of the first receive chain to the second baseband filter of the second receive chain. The second routing circuitry 1004 also includes two routing paths for the second mixer, such as a third routing path from a second mixer of the second receive chain to the second baseband filter of the second receive chain, and a fourth routing path from the second mixer of the second receive chain to the first baseband filter of the first receive chain. The second routing circuitry 1004 also includes two routing paths for the third mixer, such as a fifth routing path from a third mixer of a third receive chain to the second baseband filter of the second receive chain, and a sixth routing path from the third mixer of the third receive chain to a third baseband filter of the third receive chain. As illustrated in the example of FIG. 10B, the second routing circuitry 1004 include inter-chains routing paths for mixers to less than all of baseband filters.

FIG. 10C corresponds to a block diagram illustrating another example of routing circuitry for more than two receive chains, third routing circuitry 1006. The third routing circuitry 1006 may include more than two paths for at least one mixer of the three mixers. For example, a first path from the mixer to a corresponding baseband filter on the same receive chain (e.g., inter-chain), and multiple additional paths from the mixer to other baseband filters on different receive chains (e.g., intra-chain). To illustrate, the third routing circuitry 1006 includes a first routing path from the first mixer of the first receive chain to the first baseband filter of the first receive chain, a second routing path from the first mixer of the first receive chain to the second baseband filter of the second receive chain, and a third routing path from the first mixer of the first receive chain to a third baseband filter of the third receive chain. The routing paths for the other mixers are not shown in FIG. 10C for clarity and simplicity. In some aspects, the third routing circuitry 1006 includes two or more than two routing paths for each of the additional mixers. Additionally, although the third routing circuitry 1006 includes only three mixers in the example of FIG. 10C, in other aspects the third routing circuitry 1006 includes more than three mixers and/or more than two inter-chain routing paths for at least one of the receive chains and mixers.

FIG. 11 is a block diagram illustrating an example of DPD circuitry 1100 according to one or more aspects. The DPD circuitry 1100 may include or correspond to DPD front end circuitry or a DPD front end module of a transceiver, as described with reference to FIGS. 4-9. For example, the DPD circuitry 1100 may include or correspond to the feedback circuitry 462 of FIG. 4, the DPD FE circuitry 586 or 588 of FIG. 5, the DPD FE circuitry 686 or 688 of FIG. 6, the DPD FE circuitry 786 or 788 of FIGS. 7-9.

The DPD circuitry 1100 is configured to sample a power amplifier output and generate DPD feedback. For example, the DPD circuitry 1100 may be configured to sample undistorted or uncompensated transmission signals to generate feedback for the undistorted or uncompensated transmission signals. The feedback may then be used, such as by a predistorter or digital baseband processor (e.g., predistortion circuitry thereof), to generate a distorted or compensated transmission signal for transmission that when amplified by transmit chain circuitry (e.g., power amplifier thereof) has increased linearity and performance.

As illustrated in FIG. 11, the DPD circuitry 1100 includes a capacitive attenuator 1102 and a voltage-to-current converter 1104. The capacitive attenuator 1102 is configured to process the amplified signal from the power simplifier of the transmit chain for further DPD processing, such as sampling. For example, the capacitive attenuator 1102 may reduce a power of the amplified signal or apply a loss.

In the example of FIG. 11, the capacitive attenuator 1102 includes a first capacitor 1112 and a second capacitor 1114 (e.g., a tuning capacitor). In some aspects, the first capacitor 1112 may include or correspond to a fixed capacitor with a fixed or static capacitance, and the second capacitor 1114 may include or correspond to a variable capacitor with a dynamic or adjustable capacitance. The capacitance of the second capacitor 1114 may be adjusted by electrical or mechanical means. Alternatively, the second capacitor 1114 when variable may include or correspond to multiple fixed capacitance capacitors when can be used to get multiple different capacitance values, such as by a network of capacitors. The capacitance of the second capacitor 1114 may be adjusted by a controller, such as digital baseband processor or controller, as described with reference to FIGS. 3-9.

In some aspects, the first capacitor 1112 includes an input coupled to an input of the capacitive attenuator 1102 and configured to receive an output from the power amplifier. The first capacitor 1112 includes an output coupled to an output of the capacitive attenuator 1102 and coupled to an input of the second capacitor 1114 and configured to provide an output to both the second capacitor 1114 and the voltage-to-current converter 1104 (via the output of the capacitive attenuator 1102). The second capacitor 1114 includes an input coupled to an output of the capacitive attenuator 1102 and coupled to the output of the first capacitor 1112 and configured to receive an output from the first capacitor 1112. The second capacitor 1114 includes an output coupled to ground.

In some aspects, the capacitive attenuator 1102 may include additional components, such as additional passive components. For example, the capacitive attenuator 1102 may include one or more resistors and/or may include additional paths for different frequency ranges.

The voltage-to-current converter 1104 is configured to convert a voltage received from the capacitive attenuator 1102 to a current, and to provide the current back to a baseband filter via routing circuitry. In some aspects, the voltage-to-current converter 1104 is configured to sample the output from the capacitive attenuator 1102.

The voltage-to-current converter 1104 may include or correspond to circuitry configured to convert a voltage or voltage signal to a current or current signal. The voltage-to-current converter 1104 produces a current that is directly proportional to the applied voltage. Thus, voltage changes or fluctuations in the input signal are converted to current changes in the output signal. As an illustrative, non-limiting example, the voltage-to-current converter 1104 may include or correspond to an amplifier, such as an operational differential amplifier. In some such aspects, the operational differential amplifier may be arranged as a ground or floating load voltage to current converter.

During operation, a power amplifier output signal 1132 is provided to the capacitive attenuator 1102. The capacitive attenuator 1102 provides the power amplifier output signal to the first capacitor 1112, which has a constant capacitance value (e.g., C1). The second capacitor 1114 has a programmable capacitance value (e.g., C2), and the programmable capacitance value may be set based on or according to an output power level of the power amplifier. The capacitive attenuator 1102, such as the first and second capacitors 1112 and 114 thereof, process the signal for conversion by the voltage-to-current converter 1104. To illustrate, the first and second capacitors 1112 and 114 may attenuate or reduce a power level of the signal prior to conversion/sampling.

The attenuated power amplifier output signal is provided from the capacitive attenuator 1102 to the voltage-to-current converter 1104. The voltage-to-current converter 1104 generates a DPD feedback signal 1134 based on the attenuated power amplifier output signal. For example, the voltage-to-current converter 1104 (e.g., an op-amp thereof) generates a current that is directly proportional to the applied voltage of the attenuated power amplifier output signal. The generation of the DPD feedback signal 1134, that is the conversion from the attenuated power amplifier output signal to the DPD feedback signal 1134, may involve a converter or conversion gain. The conversion gain may be adjusted or programmed by adjusting a DC current into the voltage-to-current converter 1104 (e.g., an op-amp thereof) and the conversion gain may be set based on an output power level of the power amplifier, the programable capacitance value of the capacitive attenuator 1102, or both. While discussed in the context of DPD, it should be appreciated that the circuitry of FIG. 11 may be used for other purposes where feedback paths are employed. Other circuitry for sampling the transmit path output may include couplers or other techniques for sampling a portion of the output of the transmit path.

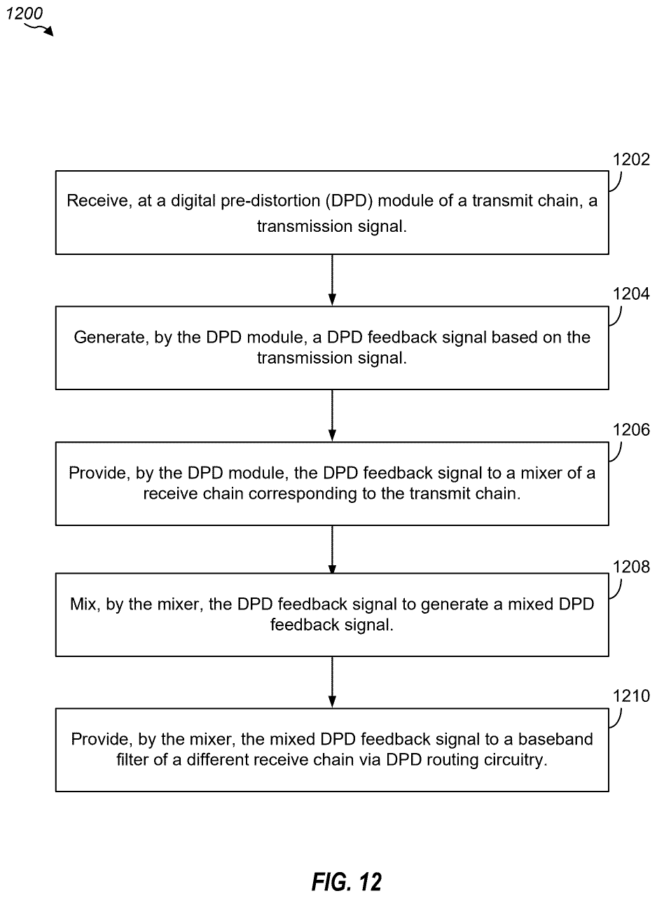

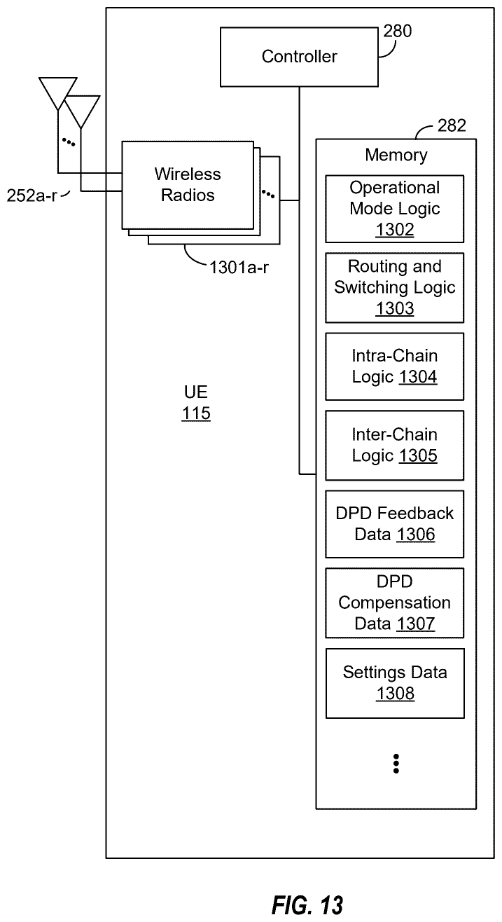

FIG. 12 is a flow diagram 1200 illustrating example blocks executed by a wireless communication device (e.g., a UE or base station) configured according to an aspect of the present disclosure. The example blocks will also be described with respect to UE 115 as illustrated in FIG. 13. FIG. 13 is a block diagram illustrating UE 115 configured according to one aspect of the present disclosure. UE 115 includes the structure, hardware, and components as illustrated for UE 115 of FIGS. 2-11. For example, UE 115 includes controller/processor 280, which operates to execute logic or computer instructions stored in memory 282, as well as controlling the components of UE 115 that provide the features and functionality of UE 115. UE 115, under control of controller/processor 280, transmits and receives signals via wireless radios 1301a-r and antennas 252a-r. Wireless radios 1301a-r includes various components and hardware, as illustrated in FIG. 2 for UE 115, including modulator/demodulators 254a-r, MIMO detector 256, receive processor 258, transmit processor 264, and TX MIMO processor 266. As illustrated in the example of FIG. 13, memory 282 stores operational mode logic 1302, routing and switching logic 1303, intra-chain logic 1304, inter-chain logic 1305, DPD feedback data 1306, DPD compensation data 1307, and settings data 1308. The data (1302-1308) stored in the memory 282 may include or correspond to data and/or logic to enable the operations described FIGS. 4-11.

For example, the operational mode logic 1302 may include or correspond to data for controlling different operating modes of the wireless device and the routing and switching logic 1303 may include or correspond to data for controlling the routing of DPD feedback signals for different modes, such as different RF output power modes, different bandwidth or frequency modes (e.g., Wi-Fi or cellular), etc. The intra-chain logic 1304 and the inter-chain logic may include or correspond to data for controlling the operations of the DPD routing circuitry to provide intra-chain and inter-chain paths, such as controlling operations of the switches of the DPD routing circuitry. The DPD feedback data 1306 may include or correspond to data for controlling the DPD compensation operations by the baseband processor. The DPD compensation data 1307 may include or correspond to data or signals for wireless transmission generated based on the DPD feedback data 1306, such as for different RF output powers indicated by the settings data 1308.

At block 1202, a wireless communication device, such as a UE or a base station, receives, at a digital pre-distortion (DPD) module of a transmit chain, a transmission signal. The DPD module may include to DPD front end circuitry as described with reference to FIGS. 4-11, such as feedback circuitry 462, DPD FE circuitry 586 or 588 of FIG. 5, DPD FE circuitry 686 or 688 of FIG. 6, DPD FE circuitry 786 or 788 of FIGS. 7-9, or DPD circuitry 1100 of FIG. 11. The transmit chain may include or correspond a transmit chain of any of the receivers or transceivers as described with reference to FIGS. 3-9, such as a transmit chain of transmit chains 512 or 516 of FIG. 5, transmit chains 612 or 616 of FIG. 6, transmit chains 712 or 718 of FIG. 7 or 8, or transmit chains 912 or 918 of FIG. 9. The transmission signal may include or correspond to an input or amplified RF input signal received at DPD front end circuitry of or associated with the transmit chain, as described with reference to FIGS. 4-11, such as power amplifier output signal 1132 of FIG. 11. As one illustrative example, the DPD FE circuitry 786 receives an amplified transmission signal in the RF frequency range for DPD processing from the power amplifier 746 of the first transmit chain 712 of the first channel 702, as described with reference to FIG. 7. Many other examples are described in FIGS. 4-11.

At block 1204, the wireless communication device generates, by the DPD module, a DPD feedback signal based on the transmission signal. The DPD feedback signal may include or correspond to DPD feedback signal generated by DPD front end circuitry of or associated with the transmit chain, as described with reference to FIGS. 4-11, such as DPD feedback signal 1134 of FIG. 11. As one illustrative example, the DPD FE circuitry 786 generates a DPD feedback signal based on DPD processing the received amplified RF signal from the power amplifier 746 of the first transmit chain 712 of the first channel 702, as described with reference to FIG. 7. Many other examples are described in FIGS. 4-11.

At block 1206, the wireless communication device provides, by the DPD module, the DPD feedback signal to a mixer of a receive chain corresponding to the transmit chain. The mixer may include to mixer of a receive chain as described with reference to FIGS. 4-11, such as a mixer of mixers 534 or 538 of FIG. 5, mixers 634 or 638 of FIG. 6, or mixers 734 or 736 of FIGS. 7-9. The receive chain may include or correspond a receive chain of any of the receivers or transceivers as described with reference to FIGS. 3-9, such as a receive chain of receive chains 514 or 518 of FIG. 5, receive chains 614 or 618 of FIG. 6, receive chains 714 or 716 of FIG. 7 or 8, or receive chains 914 or 916 of FIG. 9. The receive chain and transmit chain may be part of one channel, such as first channel 702 or 902, and may share one or more components, such as a baseband filter in some aspects. As one illustrative example, the DPD FE circuitry 786 generates a DPD feedback signal based on DPD processing the amplified RF signal received from the power amplifier 746 of the first transmit chain 712 of the first channel 702, as described with reference to FIG. 7. Many other examples are described in FIGS. 4-11.

At block 1208, the wireless communication device mixes, by the mixer, the DPD feedback signal to generate a mixed DPD feedback signal. The mixed DPD feedback signal may include or correspond to a downconverted DPD feedback signal or baseband DPD feedback signal as described with reference to FIGS. 4-11, such as the baseband DPD feedback signals of FIGS. 10A-10C. As one illustrative example, the mixer 734 generates a downconverted DPD feedback signal based on mixing the received DPD feedback signal from the DPD FE circuitry 786 with a received LO signal from the LO circuitry 782, as described with reference to FIG. 7. Many other examples are described in FIGS. 4-11. Because the DPD feedback signal was provided to a mixer of the first receive chain intra-chain in the RF region, the DPD routing path is shorter and has reduced unwanted coupling and interference.

At block 1210, the wireless communication device provides, by the mixer, the mixed DPD feedback signal to a baseband filter of a different receive chain via DPD routing circuitry. The baseband filter may include or correspond to a dedicated receive baseband filter or a shared baseband filter as described with reference to FIGS. 4-8, such as a baseband filter of shared baseband filters 722 or 724 of FIG. 7 or receive baseband filters 924 or 926 of FIG. 7. As one illustrative example, the routing circuitry 726 provides the downconverted or baseband DPD feedback signal received from the mixer 734 on the first receive chain 714 of the first channel 702 to either of the first shared baseband filter 722 of the first channel 702 or the second shared baseband filter 724 of the second channel 704, as described with reference to FIG. 7.

As another illustrative example, the routing circuitry 802 provides the downconverted or baseband DPD feedback signal received from the mixer 734 on the first receive chain 914 of the first channel 902 to either of the first receive baseband filter 924 of the first receive chain 914 and the first channel 902, or the second receive baseband filter 926 of the second receive chain 914 and the second channel 904, as described with reference to FIG. 9. Many other examples are described in FIGS. 4-11. Because the downconverted or baseband DPD feedback signal can be provided either intra-chain or inter-chain by the DPD routing circuitry, the transceiver has increased performance as compared to conventional inter-chain routing and increased compatibility with different transceiver designs (e.g., shared baseband filter designs) as compared to conventional intra-chain routing.

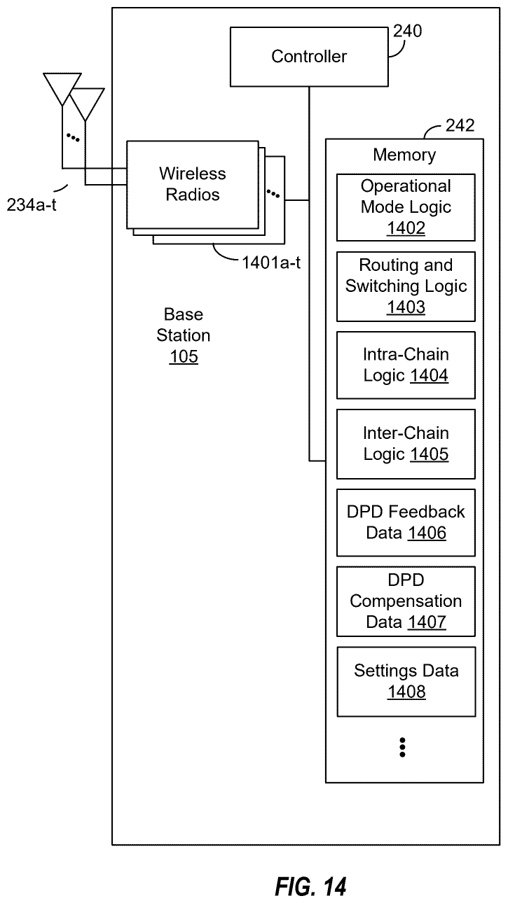

Although the operations of FIG. 12 may be directed to operation in a particular mode or with a particular input power (e.g., intermediate input powers for wideband modes), the two-stage LNA may operate in other manners for different operating modes and/or input powers. Additionally, or alternatively, although the operations of FIG. 12 were described with reference to UE 115 of FIG. 13, the operations of FIG. 12 may be performed by other wireless communication devices, such as a network device (e.g., base station 105 of FIG. 14).

Referring to FIG. 14, FIG. 14 is a block diagram illustrating base station 105 configured according to one aspect of the present disclosure. Base station 105 includes the structure, hardware, and components as illustrated for base station 105 of any of FIGS. 2-9. For example, base station 105 includes controller/processor 240, which operates to execute logic or computer instructions stored in memory 242, as well as controlling the components of base station 105 that provide the features and functionality of base station 105. Base station 105, under control of controller/processor 240, transmits and receives signals via wireless radios 1401a-t and antennas 234a-t. Wireless radios 1401a-t includes various components and hardware, as illustrated in FIG. 2 for base station 105, including modulator/demodulators 232a-t, MIMO detector 236, receive processor 238, transmit processor 220, and TX MIMO processor 230. As illustrated in the example of FIG. 14, memory 242 stores operational mode logic 1402, routing and switching logic 1403, intra-chain logic 1404, inter-chain logic 1405, DPD feedback data 1406, DPD compensation data 1407, and settings data 1408. The data (1402-1408) stored in the memory 242 may include or correspond to data and/or logic to enable the operations of FIGS. 4-9, and/or the data (1102-1108) of FIG. 11.

With reference to FIGS. 12-14, the wireless communication devices described herein (e.g., UE 115 of FIG. 13 or base station 105 of FIG. 14) may execute additional blocks (or the wireless communication device may be configured further perform additional operations) in other implementations. For example, the wireless communication device may perform one or more operations described above, such as described with reference to FIGS. 4-11. As another example, the wireless communication device may perform one or more aspects as presented below.

Accordingly, wireless communication devices may be able to more efficiently perform reception and transmission operations by utilizing enhanced hybrid DPD routing operations and DPD routing circuitry. Improved efficiency through enhanced and hybrid and configurable DPD routing paths reduces overall power consumption and enables longer battery life and improves signal quality through reduced coupling and interference. Accordingly, the device performance and experience may be increased due to the reduction in power usage and improved signal quality.

In a first aspect, a transceiver includes: a first transmit chain including a power amplifier; a first receive chain including a first mixer and a first baseband filter, wherein the first transmit chain and the first receive chain are associated with each other; a second receive chain including a second baseband filter and associated with a second transmit chain; feedback circuitry coupled to the power amplifier of the first transmit chain and to the first mixer of the first receive chain and configured to output a feedback signal to the first mixer; and feedback routing circuitry coupled to the first baseband filter and the first mixer of the first receive chain and to the second baseband filter of the second receive chain, and configured to provide the feedback signal received from the first mixer to the first baseband filter of the first receive chain or to the second baseband filter of the second receive chain.

In a second aspect, alone or in combination with the first aspect, the first receive chain and the first transmit chain are part of a first channel, wherein the second receive chain and the second transmit chain are part of a second channel, and wherein the feedback signal is a digital pre-distortion (DPD) feedback signal.

In a third aspect, alone or in combination with one or more of the above aspects, the feedback routing circuitry includes a plurality of switches, and the transceiver further includes: a controller configured to operate the plurality of switches to generate a plurality of routing paths including: a first routing path from the first mixer of the first receive chain to the first baseband filter of the first receive chain; a second routing path from the first mixer of the first receive chain to the second baseband filter of the second receive chain; a third routing path from a second mixer of the second receive chain to the second baseband filter of the second receive chain; and a fourth routing path from the second mixer of the second receive chain to the first baseband filter of the first receive chain.

In a fourth aspect, alone or in combination with one or more of the above aspects, the feedback routing circuitry includes: a first switch coupled to a second switch, a third switch, the first mixer, and the first baseband filter; the second switch coupled to the first switch, the third switch, a fourth switch, a fifth switch, a seventh switch, and an eighth switch; the third switch coupled to the first mixer, the first switch, the second switch, the fourth switch, the fifth switch, the seventh switch and the eighth switch; the fourth switch coupled to the second switch, the third switch, the fifth switch, the seventh switch, the eighth switch, and ground; the fifth switch coupled to the second switch, the third switch, the fourth switch, a sixth switch, the seventh switch, and the eighth switch; the sixth switch coupled to a second mixer of the second receive chain, the second baseband filter, the fifth switch, and the seventh switch; the seventh switch coupled to the second mixer, the second switch, the third switch, the fourth switch, the fifth switch, the sixth switch, and the eighth switch; and the eighth switch coupled to the second switch, the third switch, the fifth switch, the seventh switch, and ground.

In a fifth aspect, alone or in combination with one or more of the above aspects, the first baseband filter is further coupled to the first transmit chain and corresponds to a shared baseband filter for a first channel including the first transmit chain and the first receive chain.

In a sixth aspect, alone or in combination with one or more of the above aspects, the transceiver further includes: a third baseband filter coupled to the first transmit chain, and wherein the first and third baseband filter correspond to dedicated baseband filters for a first channel including the first transmit chain and the first receive chain.

In a seventh aspect, alone or in combination with one or more of the above aspects, the feedback routing circuitry includes a plurality paths and is configured to provide the feedback to: the first baseband filter of the first receive chain associated with the first transmit chain and a first channel; the second baseband filter of the second receive chain associated with the second transmit chain and a second channel; or a third baseband filter of a third receive chain associated with a third transmit chain and a third channel.

In an eighth aspect, alone or in combination with one or more of the above aspects, the first transmit chain includes: a third mixer coupled to the first baseband filter or a third baseband filter; a differential amplifier coupled to the third mixer; and a preamplifier coupled to the differential amplifier and to the power amplifier.

In a ninth aspect, alone or in combination with one or more of the above aspects, the first transmit chain includes: a transformer including an input coupled to an output of the power amplifier and an output coupled to an antenna.

In some aspects, the first receive chain includes: a LNA amplifier including an input coupled to an antenna and including an output coupled to an input of the first mixer. Additionally, or alternatively, the first receive chain includes: a second amplifier including an input coupled to the output of the LNA amplifier and including an output coupled to the input of the first mixer.

In a tenth aspect, alone or in combination with one or more of the above aspects, the transceiver further includes: second feedback circuitry coupled to a second power amplifier of the second transmit chain and to a second mixer of the second receive chain and configured to output a second feedback signal to the second mixer.

In an eleventh aspect, alone or in combination with one or more of the above aspects, the feedback circuitry comprises DPD feedback circuitry that includes a capacitive attenuator and a voltage-to-current converter.

In a twelfth aspect, alone or in combination with one or more of the above aspects, the capacitive attenuator comprises: a first capacitor including an input coupled to an input of the capacitive attenuator and including an output coupled to an output of the capacitive attenuator and to a second capacitor; and the second capacitor including an input coupled to the output of the first capacitor and to the output of the capacitive attenuator and including an output coupled to ground, the second capacitor is a variable capacitor.

In some aspects, the feedback circuitry corresponds to DPD front end circuitry configured to sample an output of a power amplifier of the transmit chain to generate the DPD feedback, and wherein the DPD FE circuitry is coupled to an output of the power amplifier of the first transmit chain and to an input of the first mixer of the first receive chain.

In a thirteenth aspect, alone or in combination with one or more of the above aspects, the transceiver further includes: a switch coupled to an output of the feedback circuitry and an input of the first mixer, wherein the switch is configured to be closed during feedback operations and to be open during transmission operations on the first transmit chain, wherein the feedback signal provided to the first mixer is in a radiofrequency frequency spectrum and is routed intra-chain, and wherein the feedback signal provided by the first mixer is in a baseband frequency spectrum and is routed inter-chain.

In a fourteenth aspect, alone or in combination with one or more of the above aspects, the transceiver further includes: a digital baseband processor coupled to the first transmit and second transmit chains and to the first and second baseband filters of the first and second receive chains and configured to generate baseband signals for wireless transmission and to process received wireless signals and the feedback signal; and digital pre-distortion (DPD) adjustment circuitry coupled to the digital baseband processor and configured to adjust the baseband signals to compensate for distortion caused by the power amplifier of the first transmit chain.

In some aspects the transceiver further includes: a predistorter coupled to the digital baseband processor and configured to generated DPD compensated transmission signals based on the DPD feedback from the DPD circuitry. Additionally, or alternatively, the transceiver further includes LO circuitry configured to generate LO signals and to provide the LO signals to the first mixer of the first receive chain or includes LO circuitry configured to generate LO signals and to provide the LO signals to mixers of at least the first transmit chain and the first receive chain.

In a fifteenth aspect, a transceiver includes: a first transmit chain including a first power amplifier; a first receive chain including a first mixer and a first baseband filter; a first shared baseband filter coupled to a first transmit chain and the first receive chain; a second receive chain including a second mixer and second baseband filter; a second shared baseband filter coupled to a second transmit chain and the second receive chain; feedback circuitry including an input coupled to an output of the first power amplifier of the first transmit chain and an output coupled to an input of the first mixer of the first receive chain; and routing circuitry coupled to the first shared baseband filter, the second shared baseband filter, the first mixer of the first receive chain, and the second mixer of the second receive chain, and including multiple routing paths, the multiple routing paths including intra-chain receive signal paths and inter-chain feedback signal paths.

In a sixteenth aspect, alone or in combination with one or more of the above aspects, the routing circuitry includes: a first switch having an input terminal coupled to the first mixer and an input terminal of a third switch and having an output terminal coupled to an input terminal of the first baseband filter and to an input terminal of a second switch; the second switch having an output terminal coupled to an input terminal of a fourth switch and an output terminal of the third switch; the third switch having an input terminal coupled to the output terminal of the first mixer and an output terminal coupled to the input terminal of the fourth switch, an input terminal of a fifth switch, an input terminal of a seventh switch and an input terminal of an eighth switch; the fourth switch having an output terminal coupled to ground; the fifth switch having the input terminal coupled to the input terminal of the eighth switch and having an output terminal coupled to an input terminal of the second baseband filter and to an output terminal of a sixth switch; the sixth switch having an input terminal coupled to an output terminal of the second mixer and the output terminal coupled to the input terminal of the second baseband filter; the seventh switch having an output terminal coupled to the output terminal of the second mixer; and the eighth switch having an output terminal coupled to ground.

In a seventeenth aspect, alone or in combination with one or more of the above aspects, the feedback circuitry comprises DPD circuitry that includes a capacitive attenuator and a voltage-to-current converter, and wherein the capacitive attenuator comprises: a first capacitor including an input coupled to an input of the capacitive attenuator and including an output coupled to an output of the capacitive attenuator and to a second capacitor; and the second capacitor including an input coupled to the output of the first capacitor and to the output of the capacitive attenuator and including an output coupled to ground, the second capacitor is a variable capacitor.

In an eighteenth aspect, a method for wireless communication includes: generating, by the feedback module, a feedback signal based on the transmission signal; providing, by the feedback module, the feedback signal to a mixer of a receive chain corresponding to the transmit chain; mixing, by the mixer, the feedback signal to generate a mixed feedback signal; and providing, by the mixer, the mixed feedback signal to a baseband filter of a different receive chain via feedback routing circuitry.

In a nineteenth aspect, alone or in combination with one or more of the above aspects, the method further includes: modifying the transmission signal based on the mixed feedback signal to generate a modified transmission signal; and transmitting the modified transmission signal via an antenna.

In a twentieth aspect, alone or in combination with one or more of the above aspects, the method further includes: receiving a wireless signal via an antenna coupled to the receive chain; processing, by components of the receive chain, the wireless signal; mixing, by the mixer, the processed wireless signal to generate a mixed wireless signal; and providing, by the mixer, the mixed wireless signal to a second baseband filter of the receive chain via the feedback routing circuitry.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-13 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIGS. 3 and 4 may be combined with one or more blocks (or operations) described with reference to another of the figures. For example, one or more blocks (or operations) of FIG. 3 may be combined with one or more blocks (or operations) of FIG. 1. As another example, one or more blocks associated with FIG. 4 may be combined with one or more blocks (or operations) associated with FIG. 1. Additionally, or alternatively, one or more operations described above with reference to FIGS. 1-4 may be combined with one or more operations described with reference to FIGS. 5-13

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, opposing terms such as “upper” and “lower” or “front” and back” or “top” and “bottom” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A transceiver, comprising:
a first transmit chain including a power amplifier;
a first receive chain including a first mixer and a first baseband filter, wherein the first transmit chain and the first receive chain are associated with each other;
a second receive chain including a second baseband filter and associated with a second transmit chain;
feedback circuitry coupled to the power amplifier of the first transmit chain and to the first mixer of the first receive chain and configured to output a feedback signal to the first mixer; and
feedback routing circuitry coupled to the first baseband filter and the first mixer of the first receive chain and to the second baseband filter of the second receive chain, and configured to provide the feedback signal received from the first mixer to the first baseband filter of the first receive chain or to the second baseband filter of the second receive chain.

2. The transceiver of claim 1, wherein the first receive chain and the first transmit chain are part of a first channel, wherein the second receive chain and the second transmit chain are part of a second channel, and wherein the feedback signal is a digital pre-distortion (DPD) feedback signal.

3. The transceiver of claim 1, wherein the feedback routing circuitry includes a plurality of switches, and further comprising:
a controller configured to operate the plurality of switches to generate a plurality of routing paths including:
a first routing path from the first mixer of the first receive chain to the first baseband filter of the first receive chain;
a second routing path from the first mixer of the first receive chain to the second baseband filter of the second receive chain;
a third routing path from a second mixer of the second receive chain to the second baseband filter of the second receive chain; and
a fourth routing path from the second mixer of the second receive chain to the first baseband filter of the first receive chain.

4. The transceiver of claim 1, wherein the feedback routing circuitry includes:
a first switch coupled to a second switch, a third switch, the first mixer, and the first baseband filter;
the second switch coupled to the first switch, the third switch, a fourth switch, a fifth switch, a seventh switch, and an eighth switch;
the third switch coupled to the first mixer, the first switch, the second switch, the fourth switch, the fifth switch, the seventh switch and the eighth switch;
the fourth switch coupled to the second switch, the third switch, the fifth switch, the seventh switch, the eighth switch, and ground;
the fifth switch coupled to the second switch, the third switch, the fourth switch, a sixth switch, the seventh switch, and the eighth switch;
the sixth switch coupled to a second mixer of the second receive chain, the second baseband filter, the fifth switch, and the seventh switch;
the seventh switch coupled to the second mixer, the second switch, the third switch, the fourth switch, the fifth switch, the sixth switch, and the eighth switch; and
the eighth switch coupled to the second switch, the third switch, the fifth switch, the seventh switch, and ground.

5. The transceiver of claim 1, wherein the first baseband filter is further coupled to the first transmit chain and corresponds to a shared baseband filter for a first channel including the first transmit chain and the first receive chain.

6. The transceiver of claim 1, further comprising:
a third baseband filter coupled to the first transmit chain, and wherein the first and third baseband filter correspond to dedicated baseband filters for a first channel that includes the first transmit chain and the first receive chain.

7. The transceiver of claim 1, wherein the feedback routing circuitry includes a plurality paths and is configured to provide the feedback signal to:
the first baseband filter of the first receive chain associated with the first transmit chain and a first channel;
the second baseband filter of the second receive chain associated with the second transmit chain and a second channel; or
a third baseband filter of a third receive chain associated with a third transmit chain and a third channel.

8. The transceiver of claim 1, wherein the first transmit chain includes:
a third mixer coupled to the first baseband filter or a third baseband filter;
a differential amplifier coupled to the third mixer; and
a preamplifier coupled to the differential amplifier and to the power amplifier.

9. The transceiver of claim 1, wherein the first transmit chain includes:
a transformer including an input coupled to an output of the power amplifier and an output coupled to an antenna.

10. The transceiver of claim 1, further comprising:
second feedback circuitry coupled to a second power amplifier of the second transmit chain and to a second mixer of the second receive chain and configured to output a second feedback signal to the second mixer.

11. The transceiver of claim 1, wherein the feedback circuitry includes a capacitive attenuator and a voltage-to-current converter.

12. The transceiver of claim 11, wherein the capacitive attenuator comprises:
a first capacitor including an input coupled to an input of the capacitive attenuator and including an output coupled to an output of the capacitive attenuator and to a second capacitor; and
the second capacitor including an input coupled to the output of the first capacitor and to the output of the capacitive attenuator and including an output coupled to ground, the second capacitor is a variable capacitor.

13. The transceiver of claim 1, further comprising:
a switch coupled to an output of the feedback circuitry and an input of the first mixer, wherein the switch is configured to be closed during feedback operations and to be open during transmission operations on the first transmit chain, wherein the feedback signal provided to the first mixer is in a radiofrequency frequency spectrum and is routed intra-chain, and wherein the feedback signal provided by the first mixer is in a baseband frequency spectrum and is routed inter-chain.

14. The transceiver of claim 1, further comprising:
a digital baseband processor coupled to the first transmit and second transmit chains and to the first and second baseband filters of the first and second receive chains and configured to generate baseband signals for wireless transmission and to process received wireless signals and the feedback signal; and
digital pre-distortion (DPD) adjustment circuitry coupled to the digital baseband processor and configured to adjust the baseband signals to compensate for distortion caused by the power amplifier of the first transmit chain.

15. A transceiver, comprising:
a first transmit chain including a first power amplifier;
a first receive chain including a first mixer and a first baseband filter;
a first shared baseband filter coupled to a first transmit chain and the first receive chain;
a second receive chain including a second mixer and second baseband filter;
a second shared baseband filter coupled to a second transmit chain and the second receive chain;
feedback circuitry including an input coupled to an output of the first power amplifier of the first transmit chain and an output coupled to an input of the first mixer of the first receive chain; and
routing circuitry coupled to the first shared baseband filter, the second shared baseband filter, the first mixer of the first receive chain, and the second mixer of the second receive chain, and including multiple routing paths, the multiple routing paths including intra-chain receive signal paths and inter-chain feedback signal paths.

16. The transceiver of claim 15, wherein the routing circuitry includes:
a first switch having an input terminal coupled to an output terminal of the first mixer and an input terminal of a third switch and having an output terminal coupled to an input terminal of the first baseband filter and to an input terminal of a second switch;
the second switch having an output terminal coupled to an input terminal of a fourth switch and an output terminal of the third switch;
the third switch having an input terminal coupled to the output terminal of the first mixer and an output terminal coupled to the input terminal of the fourth switch, an input terminal of a fifth switch, an input terminal of a seventh switch and an input terminal of an eighth switch;
the fourth switch having an output terminal coupled to ground;
the fifth switch having the input terminal coupled to the input terminal of the eighth switch and having an output terminal coupled to an input terminal of the second baseband filter and to an output terminal of a sixth switch;
the sixth switch having an input terminal coupled to an output terminal of the second mixer and the output terminal coupled to the input terminal of the second baseband filter;
the seventh switch having an output terminal coupled to the output terminal of the second mixer; and
the eighth switch having an output terminal coupled to ground.

17. The transceiver of claim 1, wherein the feedback circuitry comprises a digital pre-distortion (DPD) feedback circuit that includes a capacitive attenuator and a voltage-to-current converter, and wherein the capacitive attenuator comprises:
a first capacitor including an input coupled to an input of the capacitive attenuator and including an output coupled to an output of the capacitive attenuator and to a second capacitor; and
the second capacitor including an input coupled to the output of the first capacitor and to the output of the capacitive attenuator and including an output coupled to ground, the second capacitor is a variable capacitor.

18. A method for wireless communication, comprising:
generating, by a feedback circuit, a feedback signal based on a transmission signal of a transmit chain;
providing, by the feedback circuit, the feedback signal to a mixer of a receive chain corresponding to the transmit chain;
mixing, by the mixer, the feedback signal to generate a mixed feedback signal; and
providing, by the mixer, the mixed feedback signal to a baseband filter of a different receive chain via routing circuitry.

19. The method of claim 18, further comprising:
modifying the transmission signal based on the mixed feedback signal to generate a modified transmission signal; and
transmitting the modified transmission signal via an antenna.

20. The method of claim 18, further comprising:
receiving a wireless signal via an antenna coupled to the receive chain;
processing, by components of the receive chain, the wireless signal;
mixing, by the mixer, the processed wireless signal to generate a mixed wireless signal; and
providing, by the mixer, the mixed wireless signal to a second baseband filter of the receive chain via the feedback routing circuitry.
